(19) United States
(12) Patent Application Publication
(10) Pub. No.: US 2019/0392424 A1
(43) Pub. Date: Dec. 26, 2019

(54) DIGITAL TRANSACTION APPARATUS, SYSTEM, AND METHOD WITH A VIRTUAL COMPANION CARD

(71) Applicant: XARD Group Pty Ltd., Brighton (AU)

(72) Inventors: Robert Wilson, Brighton (AU); Mathieu Amiel, Brighton (AU)

(21) Appl. No.: 16/445,611

(22) Filed: Jun. 19, 2019

Related U.S. Application Data
(63) Continuation of application No. PCT/AU2017/051419, filed on Dec. 19, 2017.

(30) Foreign Application Priority Data
Dec. 19, 2016 (AU) 2016905251
Dec. 19, 2016 (AU) 2016905254
Aug. 9, 2017 (AU) 2017903183

(51) Int. Cl. G06Q 20/34; H04L 9/08; G06Q 20/38

(52) U.S. Cl. CPC G06Q 20/351; H04L 9/0897; G06Q 20/367; G06Q 2220/00; G06Q 20/3829

(57) ABSTRACT

Apparatus on a Digital Transaction Card (DTC) (222) operable in accordance with a standard command protocol, the apparatus including hardware operable with at least one application for executing one or more instructions from the standard command protocol; and software operable to store one or more software packages, at least one of the one or more software packages representing a Modified Virtual Card Profile (MVCP), the apparatus operable with the MVCP to cause the DTC(222) to adopt the personality associated with the MVCP.

### CROSS REFERENCE TO RELATED APPLICATIONS

Continuation of International Application No. PCT/AU2017/051419 filed on Dec. 19, 2017. Priority is claimed from Australian Application No. 2016905251 filed on Dec. 19, 2016, Australian Application No. 2016905254 filed on Dec. 19, 2016 and Australian Application No. 2017903183 filed on Aug. 9, 2017. All the foregoing applications are incorporated herein by reference in their entirety.

### STATEMENT REGARDING FEDERALLY SPONSORED RESEARCH OR DEVELOPMENT

Not Applicable.

### NAMES OF THE PARTIES TO A JOINT RESEARCH AGREEMENT

Not Applicable

### BACKGROUND

The present invention relates generally to apparatus, methods and systems for effecting digital transactions, including both financial and non-financial transactions.

The apparatus, methods and systems may be particularly useful for transactions involving Digital Transaction Cards (DTCs), such as credit and/or debit cards.

Transaction Types

There are two main classifications of transactions for which transaction cards or documents, including DTCs, are used:
“Card-Not-Present” transactions, when using the Internet or Mail Order/Telephone Order (MOTO) transactions, which generally require the user to read out to an operator, or enter into a computer, the Personal/Primary Account Number (PAN) and expiration date digits. In some instances, the Card Verification Code (CVC) or Card Verification Value (2) (CVV/CVV(2)) number is also required; and
“Card-Present” transactions, such as used with Point Of Sale (POS), Electronic Funds Transfer at Point Of Sale (EFTPOS), and Automatic Teller Machines (ATM) terminals. Card-Present transactions involve chip readers, including physical contact readers using electrode pins on a DTC, contactless readers, and Near Field Communication (NFC) readers; and/or magnetic stripe readers.

Financial Transaction—Card-Present

Mag-Stripe Cards

Credit cards, debit cards and other types of transaction cards or documents often include a magnetic stripe which stores information about the card or document, the holder of the card/document, an institution which has issued the card/document, and other information including card/document ID (for example, a PAN), expiry date, and the card/document holder's name. Typically, much of the information on the magnetic stripe is encoded for security.

Credit/debit cards often also have the name of the cardholder, the card expiry date and the PAN embossed on the card, and may also include other security devices such as holograms.

Credit/debit cards are enabled for transactions with digital transaction devices, such as ATMs, POS terminals, and EFTPOS terminals, where the digital transaction devices are able to read the magnetic stripe when a user swipes the stripe through or inserts the card into a device.

Chipped Cards

More recently, transaction cards, documents and other devices, such as watches and other wearable devices, have had integrated circuit chips, which can store the same information as a magnetic strip, along with much other information. In this specification, cards, documents and other devices using a chip will be referred to for convenience as Digital Transaction Cards (DTCs). The DTCs could be a physical card enabled only for contact payments, or could be a physical card enabled for both contact and contactless payments. For example, where a DTC is in the form of a wearable payment device, such as a watch, such a payment device will not have a contact plate, and can only be used for contactless payment transactions.

Further, the term DTC generally applies to a physical card with a chip, but without a magnetic stripe. However, it would be possible for some DTCs to also have a magnetic stripe.

The integrated circuit chip may be referred to as a chip, smart chip, or smart card chip. In this specification, such chips or devices or other similar types of microcircuit for digital transactions will be referred to generally as Digital Transaction Processing Units (DTPUs). DTPUs typically include one or more of a Central Processing Unit (CPU), Read Only Memory (ROM), Random Access Memory (RAM), Electrically Erasable Programmable Read Only Memory (EEPROM), a crypto-coprocessor and an Input/Output (I/O) system. DTPUs also typically include a secure memory (sometimes referred to as a secure element) for storage of confidential data. An example DTPU is a (Europay/MasterCard/Visa) EMV device, which contains data (including encrypted data) relevant to the type of transaction(s) for which the DTC will be used. The EMV device may be read by a scanner (for example, using contactless/close-proximity communications such as Near Field Communication (NFC)), by direct contact with chip connected electrodes (this may involve a contact plate fitted to the DTC, and which is connected or electrically attached to the chip), or by other means to obtain data from the chip.

If the contact plate is fitted, connected and authorised, DTCs can be used for direct contact transactions where the DTC is inserted into a digital transaction device, or NFC transactions with enabled digital transaction devices where the DTC is held against a part of or is held near the digital transaction device.

Financial Transaction—Card-Not-Present

For some transactions, the physical card need not be present, and only selected details from the card are provided to enable a transaction. Such transactions include internet transactions and MOTO transactions. For a payment transaction, a cardholder provides details over the telephone (either via an automated system or to a person), or via a secure internet portal, the details typically including the card's PAN, the cardholder's name, the card's expiry date, and the CVV2.

Transaction Security (PANs, PINs, Tokens, CVC)

Security of transactions with transaction cards or documents, including DTCs is a major concern as there have been many instances of fraudulent transaction with stolen cards/documents or stolen card/document details.

Transaction cards may also have a CVV or CVC on the magnetic stripe to make it more difficult to replicate a card for fraudulent purposes. The CVC is usually a unique cryptogram, created based on the card data, for example, including the card PAN and expiry date, and a bank's or a personalization bureau's master key, and printed on the card after personalization data is entered on the card. The same principle was subsequently adopted for another CVC sometimes called Card Verification Value 2 (CVV2), which is commonly printed in the signature panel on the back of the card. The CVV2 is used primarily to help secure e-Commerce and Internet or MOTO transactions. This is a second unique cryptogram created from card data and the bank's master key (although this is a different cryptogram as compared with the magnetic stripe CVC). The CVV2 is not present on the magnetic stripe.

Many DTCs operate with a Personal Identification Number (PIN) code known only to the cardholder(s), which must be kept confidential, and must be entered on secure and certified terminals to verify that the person is the authorized cardholder. Depending on the issuer's configuration, the PIN or the PIN offset may be stored in the DTPU for offline verification. If the PIN or the PIN offset is required to be stored locally, the PIN or the PIN offset is stored in a secure, tamper resistant memory.

There are various Card Verification Methods (CVM) supported, including:
online PIN;
offline PIN (plaintext);
offline PIN (enciphered);
signature;
combination of offline PIN and signature; and,
no CVM.

If a payment terminal (for, example an EFTPOS terminal) and a card support the same CVM, depending on CV rule, that CVM will be used for authenticating and authorizing a payment.

Another way of securing transaction is by using tokens. A token is number of same length as a PAN being an encrypted substitute for the PAN, which is transmitted during a digital transaction to a token provider (or another sufficiently enabled entity), which can decrypt the token to reveal the original PAN. In this way, the PAN may be better protected in a high risk, low security environment.

Firmware/Chipped Cards (Including EMV, Java Card, MULTOS)

Most DTPUs operate using a set of standard commands and/or processes (a standard command protocol). One example is called Global Platform Standard (GPS). The GPS command/process details are not commonly or widely published (or, at least the latest commands/processes are not published) to maintain security. GPS commands/processes are used when creating a DTC and installing a personality (for example, MasterCard, Visa, or Amex), along with personal data related to the customer onto the DTPU of the DTC. GPS commands may also be used by the DTPU during digital transactions with digital transaction devices.

Some DTPUs implement only a firmware layer in which all required card and customer details are encoded, along with operating instructions from a standard command set such as GPS. One example, is an EMV chip operating with EMV applications embedded in the firmware.

Other DTPUs or DTCs implement software (or a software layer) which operates with the firmware layer and provides a greater range of operation capabilities for the DTC. This type of DTC is sometimes referred to as a smartcard. Two example smartcard DTCs types using a software layer are Java Cards and MULTOS cards. These types of software/firmware cards can store and operate with applications in their software layer for operating their firmware layer. For example, Java Card DTCs have a container which stores applet packages, which are instantiated during an operation of the DTC to control operations in the firmware layer.

Other Financial Cards

Another type of credit card sized device includes a keyboard (or touch pad arranged as a simplified keyboard) and a small limited capability Graphical User Interface (GUI), which are used to select one card amongst a number of cards stored on the card sized device, and to enter data for various transactions. Other attempted solutions include products, such as Plastc, Coin, Final, and Wocket. However, the Plastc solution had operational limitations, and the Wocket solution requires a specific Wocket device. None of these solutions has gained wide market acceptance, and some have now closed or ceased operating.

Other Payment Systems Including Smartphones

Another means of conducting transactions is known as a digital wallet. A digital wallet refers to electronic devices and programs used for making payments for purchases digitally, without presenting a physical credit card, debit card, or cash. One type of digital wallet is a device-based digital wallet implemented, for example, on a smartphone. Examples of device based digital wallets include Apple Pay and Samsung Pay. Google Wallet and PayPal provide apps which can operate on smartphones. Device-based digital wallets implemented on NFC enabled devices such as smartphones can be used for Card-Present transactions with suitably configured digital transaction devices. Another type of digital wallet is an internet-based digital wallet which enables a user to add credit card/debit card information allowing the customer to make online purchases. Google Wallet and PayPal are examples of internet-based digital wallets.

Digital wallets may contain a number of different cards (for example, Visa, MasterCard, Amex) or card types (credit card, debit card). Some digital wallets can also be used to hold other information, such as store loyalty cards or gift cards.

For device based digital wallets the different cards/card types may be referred to as Mobile Payment Cards (MPCs) and can be securely stored in a secure element of the smartphone. It will be understood that digital wallets and MPCs could be implemented on other devices apart from smartphones, such a computer tablets or personal computers. MPCs are protected by keys held by a Trusted Service Manager (TSM). A TSM is a service platform that connects service providers, such as banks or transport companies, to secure element issuers, such as mobile operators (for the secure element on the SIM card of a mobile device) or device manufacturers (for the secure element embedded in a mobile device).

However, digital wallets on an NFC enabled device, such as a smartphone, do not operate in a large percentage of Card-Present transactions, for example, POS/EFTPOS or ATM transactions since these network transaction devices generally do not support contactless payments and amongst the presently available contactless payment arrangements, different back end processes and merchant agreements are involved. As a result, the establishment and use of digital wallets has experienced limited commercial success.

Card Creation

The manufacture of a DTC is a multi-step process usually involving a number of parties. For example, one party makes the DTPU, another party makes the DTC, yet another party embeds the DTPU in the DTC. The parties involved in manufacture and issuing of cards may be referred to as an issuing network.

A further party, sometimes known as a Personalization (or Perso) Bureau (PB), enables the DTPU to operate with a chosen personality. For example, an EMV chipped DTC may arrive at the PB with multiple containers pre-installed into the EMV's secure memory. The PB disables all except one container, which is used for holding details of a card personality, such as a MasterCard. All the information for operating the personality is loaded into the remaining container, including the PAN, cardholder details, and required security for that personality.

EMV chips can be:
Java or Multos or machine language types;
Java or Multos EMVs usually meet a version of GPS;
EMV chips are configured with enough memory split between a ROM with one or more scheme applets (different versions of schemes may be installed) pre-installed, and other memory for installing post manufacture applications during PB time;
EMV chips must be installed and attached to a contactless antenna, if needed, commonly at lamination or printing time within a secure facility; and
Different hardware spec EMV chips with different loads preinstalled are available in the market.

Initial Personalization of the EMV Chip

For most firmware only implementations of EMV, once the PB loads the PAN and other information into the EMV, the PB either physically or electronically alters the EMV chip (known as blowing the fuse) so no more information can be written to the EMV (apart from a PIN change). In other examples, the act of loading information into the EMV causes other details to be cancelled/deleted or permanently disabled, so that only one scheme (or approved information) loaded by the PB is enacted or enabled. No further schemes or information can be loaded into the EMV once the card leaves the PB.

The DTC is then provided to a customer. For DTCs, including software/chipped DTCs, the PB uses one form of a script to disable the not-to-be-used containers. This form of script is relatively simple, containing only GPS commands required to disable selected containers on the EMV chip. The script does not require a high level of security as the container disabling operation occurs before critical personality information is loaded into the EMV.

Smartcard EMV Card Creation (and Life Cycle)

Java Card is an example implementation of a smartcard EMV, wherein selected functions (applications) will not work post-card-issuance as they are locked with cryptographic keys installed by the PB. Between manufacture and final destruction, a smartcard may be in different logical states, which define which operations can be performed with the card, including:
OP_READY: card is ready for uploading of key diversification data, applications, and issuer specific structures;
INITIALIZED: card is fully prepared but not yet issued to the cardholder;
SECURED: card is issued to cardholder. Card management, including, for example, installation of applets, is possible only through an appropriate security domain;
CARD_LOCKED: card is locked due to some security policy and no card management can be performed. Card can be locked/unlocked by an authorized security domain; and
TERMINATED: card is disabled, due to card expiration or detection of the severe security threat.

The card life cycle states OP_READY and INITIALIZED are intended for use during the pre-Issuance phases of the card's life. The states SECURED, CARD_LOCKED and TERMINATED are intended for use during the post-issuance phase of the card although it is possible to terminate the card at any point during its life.

Digital Wallets and MPCs

Digital wallets are provided to a smartphone user (or to the user of another device, or internet) by a Wallet Service Provider (WSP). Typically, the user will request establishment of an account and is then provided the digital wallet application for download onto the user's smartphone.

MPCs are created, distributed and managed by a TSM. The TSM optionally receives tokens from a Token Service Provider (TSP) and other required card data from various parties, and uses these to create a MPC, which is made available to a cardholder through a secure link to download onto the cardholder's smartphone.

The WSP and TSP form an issuing network for digital wallets and MPCs.

A TSM is able to perform the following operations:
providing a container with a MPC (including PAN and keys for the MPC), which can be loaded onto a smartphone;
generating further MPCs, which can be provided for loading into an already-installed container on a smartphone; and
when a smartphone user wants to change a MPC to be the primary card, the TSM operates to change the order of MPCs and securely provides a file which can be loaded onto the smartphone to implement the change on that device.

Each of the above TSM operations is done using another form of script, different from the form of script used by a PB for a physical card. The TSM scripts typically have a more complex command set and require encryption for security of the operations because the operations include important and valuable data about the MPCs. The TSM script encryption includes information linking the script to the TSM, the smartphone and the MPC. The encryption therefore protects the script from being used by an unauthorized or incorrect TSM, on an unauthorized or incorrect smartphone, or for an unauthorized or incorrect MPC. TSM scripts have sequence information which must match sequence information retained by the TSM. This helps to ensure the correct script is being used for an operation. Scripts are used only once as a subsequent operation (even if same as a previous operation) will have different sequence information. This is also known as an anti-replay mechanism.

Scripts are not provided externally of a PB or a TSM. Scripts are used to perform certain operations on EMV chips or for MPCs while the EMV chip or the MPC information is in control of the respective PB or TSM. The EMV chip (DTC) and MPCs are provided to a cardholder after scripts have performed operations at the PB or TSM.

Accordingly, many operations available to PBs and TSMs are not available to others. For example, when a user wishes to change the primary MPC on their smartphone, the user must connect with a TSM to allow the TSM to perform required operations with a script to change the primary MPC in the digital wallet, which is then securely communicated back to the user's smartphone. This can be difficult if the user is not in a location where a communication link to the TSM can be established.

TSMs also assist with managing end-to-end communication and data transfer security, for example, between the TSM itself, a bank (operating a cardholder's card accounts and other accounts), a credit/debit card provider (issuing the cardholder's card), a telecoms company (providing a mobile network for the cardholder), and the cardholder's smartphone. In one example set of operations, the TSM performs a Key Ceremony, a one-time process in which the TSM and bank exchange keys enabling a secure connection for data file delivery. The keys are produced by the bank and encrypted inside a Hardware Security Module (HSM), to a FIPS 140 standard, and split into key parts, with different key parts managed by different key custodians. An encrypted data file is produced and sent to the TSM, which can decrypt the file with the reassembled keys, thus establishing a secure channel between the bank and the TSM. The bank creates one or more accounts, generating cardholder account data, which is processed with the HSM, producing secure payment accounts including the cardholder's name, account number and secret unique keys. The TSM is provided the account data and converts it into a contactless data package formatted for a secure element in a smartphone, the TSM then prepares the NFC package for download to the cardholder's smartphone and sends this to its own HSM. NFC includes ISO 14443 or known as contactless. The TSM uses master seed keys in a Key Management System (KMS) to produce unique keys for specific SIM/UICC cards for the smartphone, or CDMA cell phones, and the NFC data package is encrypted with the unique keys. The encrypted data is transferred Over-The-Air (OTA) to Mobile Network Operators (MNOs), which have performed a key ceremony as well. The MNO transfers the NFC data package to the cardholder's phone, which checks the keys to confirm the data is for the correct smartphone. This process ensures that the bank and M NO can know the data is authentic and delivered to the correct account holder. The data is decrypted and installed on the smartphone, after which the cardholder can use their smartphone for card payments.

This end-to-end secure communication ensures security of communication between banks and SIM/U ICC cards and CDMA mobile devices (including smartphones and other kinds of mobile device). The data will only work with the correct mobile device, the encrypted data package cannot be used if intercepted, the data can be securely transferred OTA, and no human sees any account data, numbers or keys, and no machine sees them in the clear outside the HSM. This process provides a secure bridge, for example, between multiple banks, multiple, MNOs, multiple transport authorities, and multiple marketing companies.

The processes and products of TSMs, and their co-operating banks and telecommunications providers have to-date been restricted to operating within those organizations. For example, the MPCs produced and delivered through the secure end-to-end process are only available via those organizations and processes. If a card holder wishes to obtain a new MPC or change the operating card on their mobile device, it is necessary to do this through the TSM and co-operating organizations.

Payment Networks (Including Card Schemes)

During a digital transaction, for example using a credit card, there are a number of parties involved. For a payment transaction, the parties form a payment network.

A payment network may include a card scheme. Card schemes may be a three-party scheme (closed scheme), including a merchant (for example, operating an EFTPOS terminal), a card franchisee/issuer and acquirer (for example, a bank), and the cardholder; or a four-party scheme (open scheme), including a merchant, an issuer, an acquirer, and a cardholder.

Some payment networks also include a TSP which provides tokens and decrypts tokens during a transaction. For digital wallet and MPC transactions, a payment network may also need to communicate with the WSP and/or the TSM for the digital wallet/MPC.

Network and Card Security (Keys (Multiple Sets of Asymmetric Keys for Practical Distribution), Locking/Unlocking, Security Hierarchies (IS, SDD, Application))

Payment and issuing networks require security to stop others from obtaining information which could be used for fraudulent transactions or creating counterfeit cards and MPCs.

One form of security is to establish secure channels for communication between various entities in a payment network or issuing network. The secure channels can be formed with security keys, including symmetric or asymmetric keys. Asymmetric keys (public and private key pairs) tend to be favoured as they allow for less complex key distribution. Secure channels may also be formed between a DTC and an off-card entity (for example, a bank) during a payment transaction or for some other operation, for example, updating a PIN on a card.

For example, different versions of GPS introduce different mechanisms for authentication, including Secure Channel Protocol 01, 02 and 03 (SCP01, SCP02 and SCP03). Other specifications such as ETSI, introduce different mechanisms.

Payment and issuing networks also require a security hierarchy which determines what operations and information are available to various parties within a network, and also determines what operations and information are available to various parties outside of a network. At one level of the hierarchy there is an Issuer Security Domain (ISD), which is allowed to manage card content, including loading, installing, and deleting files, packages and other data. For example, in a Java Card, package loading and application installation are allowed by using ISD keys. At a lower security level, there is a Supplementary Security Domain (SSD) for managing a set of applications and their data. SSD keys may be used for personalization of managed applications.

Another security means used in credit/debit cards is locking and unlocking of various features such as commands in accordance with a standard command protocol, such as GPS. This security means may be implemented according to a security hierarchy so that an ISD can unlock one or more particular commands allowing at least temporary access to those commands for, say, a SSD, before that ISD re-locks those commands. The SSD may also lock or unlock certain commands or features to allow operations to take place on a DTC. Locking and unlocking can enable/disable communication with an applet on a Java Card.

Other common GPS APDU commands for smartcards (which have been published) include:
DELETE: delete uniquely identifiable object, for example, a Java Card applet;
STORE_DATA: upload content of single data object;
GET_DATA: retrieve a single data object;
SET_STATUS: set the Life Cycle status;
GET_STATUS: return the Life Cycle status;
INSTALL: initiate installation, typically for a Java Card applet;
LOAD: upload file from a PC to smart card, for example, a Java Card cap file; and,
PUT_KEY: update the value of specified key.

Payment Method Identification (PSE, PPSE, Explicit Selection)

DTCs, including DTCs with firmware and firmware/software DTPUs, typically have a number of payment applications, even though the DTC is operating with one personality. For example, a DTC may be a Visa credit card, but requires multiple EMV applications in its firmware for that Visa credit card to work with different payment networks. Often different payment networks operate in different geographical regions and have a subset of EMV applications with which they will operate.

In other circumstances, a DTC may have two personalities, for example, a MasterCard credit card and a MasterCard debit card. When using the DTC for a payment it is required to have a way of selecting which of the credit card or debit card is to be used by the digital transaction device. The device will build a candidate list of EMV applications that the DTC and the device have in common.

One method for selecting the application to be used is called Explicit Selection, in which each application has an Application ID (AID). The digital transaction device tries to select all AIDs which it supports to determine which applications are present on the DTC.

Another method is by using a Payment System Environment (PSE), which is a directory of applications stored on the DTC with entries for all supported EMV applications. PSE also allows for automatic selection of an application, or for cardholder selection of an application. Further, PSE allows for sorting applications according to priority with an option for cardholder selection.

Explicit Selection and PSE can only be used for contact transactions where the DTC is inserted into a digital transaction device.

Digital transaction devices using contactless payment, for example NFC, transactions use a selection method called Proximity Payment System Environment (PPSE). The PPSE on a DTC enabled for contactless payment transactions contains the list of all card applications supported by the contactless interface, and is returned from the card in response to the digital transaction device reader issuing a SELECT command for the PPSE.

Locking and unlocking can be operated to forbid the selection of particular payment applications during the payment application selection process.

Digital transaction devices, such as POS or EFTPOS payment terminals, may extract information from a payment card in different ways. Some non-standards compliant payment terminals ignore a PSE or PPSE on a card, and extract a first AID found on the card. Some other non-standards compliant payment terminals ignore a PSE or PPSE on a card, and extract a first compatible AID found on the card. Yet other non-standards compliant payment terminals ignore a PSE or PPSE on a card, and extract all AIDs on a card. However, standards compliant payment terminals obey the PSE or PPSE on a card.

Previous Efforts to Have Multiple Cards and Shortcomings

Machine language secure elements in some EMV chips only allow for one PAN to be installed. Some providers modify a machine-language-based EMV chip to support multiple PANs from the same scheme. However, a backend infrastructure and process are then required to covert a PAN into another scheme and PAN.

Card Operating Systems, such as those operating on MultOS- and Java-based EMV chips, support containers into which applications are installed. However, with such card operating systems security and domain keys lock access to the operating system to ensure only allowed applications are installed onto the card.

A previous card payment system used a DTC having a number of tokens (or a sequential group of PANs), with each token or sets of tokens being assigned to different personalities. For example, token A may be a Visa credit card, token B a MasterCard debit card, and token C, an Amex card. The token used for a transaction was sent to an entity in the payment network to be resolved to the personality of card to be used for the digital transaction.

The tokenized-multiple-personality method has a disadvantage in requiring extensive and costly payment network infrastructure change, as there must be an entity employed to resolve tokens to the correct personality before a transaction can complete. The extra expense also adds cost to each transaction, as the expense of setting up and operating the token resolution entity must be covered.

Other Cards and Documents

Though the above discussion of background and prior art is mostly addressed to payment cards, such as debit and credit cards, it will be understood that digital transaction cards and documents are used for store cards and gift cards. Further, other types of cards such as passes, tags and small booklets are transaction documents used for various financial and non-financial transactions. For example, some jurisdictions require proof of age cards for transactions such as purchasing alcohol or entering into age restricted venues. Other examples of proof of age, or proof of identity, documents include driver licenses which are sometimes used for authentication in respect of transactions. In some countries, passports and/or other similar identification documents are issued in the form of a card, or a small booklet, and can be used for transactions where identification is required including, travel across borders or establishing a bank account.

It is an object of the present invention to overcome, or at least ameliorate, at least one of the above-mentioned problems in the prior art, and/or provide at least a useful alternative to prior art devices, systems and/or methods.

### SUMMARY OF THE INVENTION

In one aspect, the present invention provides apparatus on a Digital Transaction Card (DTC) operable in accordance with a standard command protocol, the apparatus including:
hardware operable with at least one application for executing one or more instructions from the standard command protocol; and
software operable to store one or more software packages, at least one of the one or more software packages representing a Modified Virtual Card Profile (MVCP),
   the apparatus operable with the MVCP to cause the DTC to adopt the personality associated with the MVCP.

In another aspect, the present invention provides a method for operating apparatus on a Digital Transaction Card (DTC) operable in accordance with a standard command protocol, the apparatus including:
hardware operable with at least one application for executing one or more instructions from the standard command protocol; and
software operable to store one or more software packages, at least one of the one or more software packages representing a Modified Virtual Card Profile (MVCP),
   the method including:
operating the apparatus with the MVCP to cause the DTC to adopt the personality associated with the MVCP.

In a further aspect, the present invention provides a system for digital transactions operable in accordance with a standard command protocol, the system including:
apparatus on a Digital Transaction Card (DTC) including:
   hardware operable with at least one application for executing one or more instructions from the standard command protocol; and
   software operable to store one or more software packages, at least one of the one or more software packages representing a Modified Virtual Card Profile (MVCP),
the apparatus operable with the MVCP to cause the DTC to adopt the personality associated with the MVCP; and
a MVCP distribution infrastructure including:
   at least one MVCP distribution device operable to provide at least one MVCP to the DTC.

In yet another aspect, the present invention provides a method for operating a system for digital transactions operable in accordance with a standard command protocol, the system including:
apparatus on a Digital Transaction Card (DTC) including:
   hardware operable with at least one application for executing one or more instructions from the standard command protocol; and
   software operable to store one or more software packages, at least one of the one or more software packages representing Modified Virtual Card Profile (MVCP),
the apparatus operable with the MVCP to cause the DTC to adopt the personality associated with the MVCP; and
a MVCP distribution infrastructure including:
   at least one MVCP distribution device operable to provide at least one MVCP to the DTC,
      the method including:
operating the DTC to receive at least one MVCP from the MVCP distribution device.

In another aspect, the present invention provides a method for operating a system for digital transactions operable in accordance with a standard command protocol, the system including:
apparatus on a Digital Transaction Card (DTC) including:
   hardware operable with at least one application for executing one or more instructions from the standard command protocol; and
   software operable to store one or more software packages, at least one of the one or more software packages representing a Modified Virtual Card Profile (MVCP),
the apparatus operable with the MVCP to cause the DTC to adopt the personality associated with the MVCP; and
a MVCP distribution infrastructure including:
   at least one MVCP distribution device operable to provide at least one MVCP to the DTC,
      the method including:
operating the at least one MVCP distribution device to provide at least one MVCP to the DTC.

In one aspect, the present invention provides a method including receiving, from an issuing authority, a DTC configured to operate in accordance with any one or more of the statements above.

In one other aspect, the present invention provides a method including issuing, by an issuing authority, a DTC configured to operate in accordance with any one or more of the statements above.

In a further aspect, the present invention provides a method including receiving, from an issuing authority, a DTC configured to operate in accordance with the method of any one or more of the statements above.

In yet a further aspect, the present invention provides a method including issuing, by an issuing authority, a DTC configured to operate in accordance with the method of any one or more of the statements above.

In another aspect, the present invention provides a method including issuing, by an issuing authority, operating code, including software and/or firmware, to a Digital Transaction Card (DTC) to enable the DTC to operate in accordance with any one or more of the statements above.

In yet another aspect, the present invention provides a method including issuing, by an issuing authority, operating code, including software and/or firmware, to a Digital Transaction Card (DTC) to enable the DTC to operate in accordance with the method of any one or more of the statements above.

### SUMMARY OF SOME OPTIONAL EMBODIMENTS OF THE INVENTION

A Modified Virtual Card Profile (MVCP) is a modified version of a virtual card profile made suitable for operation on a Digital Transaction Card (DTC). Virtual card profiles may be for many types of digital transaction document, such as credit cards, debit cards, loyalty cards, passports, age verification cards, ID cards, drivers' licences, and other types of digital transaction documents or cards which can be rendered as virtual cards by digitizing, and, if required, encrypting information required for the functioning of the document or card.

In embodiments, the MVCP may be a form of Modified Mobile Payment Card (MMPC). An MMPC is a modified version of a Mobile Payment Card (MPC). Standard Mobile Payment Cards (MPCs), sometimes referred to as virtual cards, may be issued by Trusted Service Managers (TSMs) or Wallet Service Providers (WSPs). These MPCs or virtual cards generally do not have a real PAN and may have only a single number identifying the card. In some instances, only a tokenised number is issued for an MPC. It will be appreciated by the skilled reader that an MPC is operable only for contactless transactions (as effected by, for example, a smartphone or other mobile payment device), however, an MPC is not operable for contact transactions (as effected by, for example, standard EMV chipped credit or debit cards).

In embodiments, a TSM, or other similar third-party entity, may be configured to issue M PCs which have been modified to be installed on a DTC, and, more-particularly, to be installed on the DTPU (or EMV) of a DTC. In embodiments, the modification of an MPC includes altering the MPC to be operable for both contact and contactless digital transactions. The MPC may then be referred to as a Modified Mobile Payment Card (MMPC). An MMPC installed on the DTC (on to the EMV chip) allows the DTC to effect both contact and contactless transactions, similarly to a standard credit or debit card operating with a standard EMV chip.

It will be appreciated that, in this specification, the term Modified Virtual Card Profile (MVCP) is used to indicate a virtual card profile, which has been modified to operate on a DTC, and includes all digital transaction documents or digital transaction cards, including payment cards and non-payment cards. The term MMPC is an MVCP, which is specific for payment cards, such as credit and debit cards. Typically, an MMPC is installed onto a Digital Transaction Processing Unit (DTPU), such as an EMV chip, which may be modified to allow for installation of one or more MMCPs. In contrast, MVCPs for non-payment cards, such as loyalty cards, passports, and ID cards, are typically not allowed to be installed on a DTPU (or EMV), as this may violate requirements set by EMVCo or other organizations. Instead, an MVCP for a non-payment card can be installed, copied to or otherwise located into secure memory outside of the DTPU, for example, on a Micro Processing Unit (MCU) external to the DTPU.

Further, in this specification, the example embodiments, such as those depicted in the Figures, are focussed on a DTC operable with one or more MMPCs for payment cards, such as credit or debit cards. However, it will be appreciated that the DTCs can readily be operable with one or more MVCPs for non-payment cards. In some instances, in this specification, the terms MVCP and MMPC may be used interchangeably.

The term personality is sometimes applied to refer to a particular card which presents on a DTC when the DTC is used for a digital transaction. In embodiments of the present invention, the DTC may have one or more personalities which can be individually selected for presentation during a digital transaction. An MVCP may have the personality of either a payment or a non-payment card. An MMPC may have the personality only of a payment card.

Sometimes hardware in a DTC may be referred to as a hardware layer, and software in a DTC may be referred to as a software layer. Similarly, firmware in a DTC may be referred to as a firmware layer. It will be understood that the terms software layer, hardware layer and/or firmware layer are references to logical layers and such layers are not necessarily represented by physical layers in a DTC. It will also be understood that in embodiments the software (or software layer) controls operations in the hardware (or hardware layer), or the software (or software layer) controls operations in the firmware (or firmware layer), and that the software (or software layer) typically has lower permissions than the hardware (or hardware layer) in a security hierarchy.

In some embodiments, the apparatus is operable to store at least one script, the script when executed, operable with at least one of the one or more software packages to cause the DTC to operate in accordance with at least one command from the standard command protocol. In various embodiments, the script is issued by an authenticated third-party, for example, a Trusted Service Manager (TSM).

In some embodiments, the DTC is adapted to securely store keys (or key pairs) for ISD and/or SSD authentication/authorization, or for other authentication/authorization and/or other appropriate security rights. A key or key pair can operate in cooperation with a script to provide the required authentication for a security hierarchy, for example, to authorize operations on the DTPU (EMV). In some instances, a key or key pair could provide a higher-level security authorization/authentication than allowed for within the script (which may have its own security keys or key pairs). In embodiments, keys or key pairs can be stored in a secure element. The secure element can be located on a chip on the DTC external to the DTPU (EMV), for example, on a chip including a Micro Controller Unit (MCU). In other embodiments, the secure element could be located on the DTPU (EMV chip) itself.

In other embodiments, the method includes operating at least one script with at least one of the one or more software packages to cause the DTC to operate in accordance with at least one command from the standard command protocol.

In various embodiments, the at least one application for executing one or more instructions from the standard command protocol is a firmware application or firmware code.

In embodiments, the DTC is configured with abilities to emulate selected facilities of a TSM, such as the ability to change which card profile is the primary or operating card personality. Ordinarily, a TSM would be used to make such changes with one or more secure scripts and then transfer the changed operating state to a mobile device, such as a smartphone. In the present embodiment, such facilities for changing operating personality are located on the DTC itself, thus the changes can be performed remotely from a TSM and without the DTC needing to be in communication with a TSM to effect such changes.

In yet other embodiments, the system includes a script distribution infrastructure, including at least one script distribution device operable to provide at least one script to the DTC. In some embodiments, at least one of the MVCP distribution devices is also operable as a script distribution device.

In embodiments, the DTC includes a Digital Transaction Processing Unit (DTPU), the DTPU operating in accordance with a standard command protocol. In some embodiments, the DTPU includes the hardware and the software.

In other embodiments, the DTC includes a Micro Controller Unit (MCU). The MCU may be separate from the DTPU, and configured to operate with the DTPU. In yet other embodiments, the software layer is located in part or entirely on the MCU. In further embodiments, the MCU is configured to emulate at least some functions of a digital transaction device, such as an Automatic Teller Machine (ATM), a Point Of Sale (POS) terminal, or an Electronic Funds Transfer at Point Of Sale (EFTPOS) terminal.

In some embodiments, the at least one script includes cryptographic data to enable operations requiring cryptographic function to operate. As such the script contains both one or more commands and cryptographic data. The cryptographic data may be in the form of key pairs, including public and private keys (asymmetric keys).

In embodiments, the cryptographic data may include multiple sets of keys, for example, a first set of keys may allow the script and instruction package to securely communicate with the DTPU, and a second set of keys are transmitted via the secure communication to allow for operations on the DTPU requiring the second set of keys. Further, the key pairs may represent a hierarchical security structure with some key pairs allowing authentication and greater access to secure data or secure processes than other key pairs.

In some embodiments, a security hierarchy is implemented wherein a TSM has the highest security permissions in the hierarchy allowing the TSM to create scripts and determine which entities lower in the hierarchy are permitted to use the scripts. The TSM can also determine what the permitted entities lower in the hierarchy can do with the scripts. In one example embodiment, the TSM creates and distributes scripts to permitted entities, one such entity may be a cardholder's smartphone, which can download the scripts from the TSM, however, the smartphone does not have permission to see the contents of the scripts or perform any operations with the scripts, the smartphone is only permitted to forward the scripts to a designated DTC (typically, also belonging to the cardholder). The scripts are loaded to the MCU of the DTC, but the MCU can send certain scripts that include functions, such as locking/unlocking MMPCs (the profiles may be identified through their AIDs). The MCU (when emulating a digital transaction device, such as an ATM or POS/EFTPOS terminal) also has permission to pass some information (files, applications, keys and other data) to the DTPU. The DTPU may then perform permitted operations according to the information provided by the script through the MCU. The script could also allow the MCU to pass information to the DTPU not contained in the script, but permitted by the script. By using such hierarchies, ultimate control of the use of scripts can be retained by the TSM even when the scripts are being used outside of the TSM. Further, the TSM can allow higher security operations and information in scripts to be accessed by an entity or device which is not in direct communication with the TSM, such as a DTPU, after the script and its contents have passed through, for example, a smartphone and an MCU.

It will be appreciated that the above example of scripts being created by a TSM and passed through to a smartphone, MCU thence to a DTPU, is illustrative, and there are various other paths that scripts could be sent through to reach a DTPU or to effect operations on a DTPU. The permissions can be determined and implemented by the TSM by appropriate selection of asymmetric keys (public key/private key pairs), wherein the script may contain operations, operation permissions and/or data encrypted with a public key, the private key of which is held, for example, by the DTPU. Public and private key pairs used in such ways are sometimes referred to as a Public Key Infrastructure (PKI).

A script may also use session keys, which are generated for a one-time use or for limited time use. For example, a locking operation is permitted by a key pair, but after the locking operation is executed, the key pair becomes redundant and can no longer be used to permit a same operation (or any other operation). In other embodiments, a script could include Secure Card Protocol (SCP).

In other embodiments, a script can be used for authentication and may use mutual authentication, data ciphering, and data MACing. The mutual authentication can use a generated random value based on the targeted AID, an authentications counter, MAC using SSD keys and a constant defined by GPS.

Scripts are required by standard command protocols, such as Global Platform Standards (GPS), to conform with sequence counting procedures (for example, an authentications counter). As such, for compliance the sequence count in scripts may be required to be in synchrony with a sequence count operating on the DTPU and a sequence count retained by a Trusted Service Manager (TSM). Once a script with a particular sequence number is used, that sequence number cannot be used again, and the script is exhausted. As each script is exhausted after operating with at least one of the one or more software packages to cause the DTC to operate in accordance with at least one command from the standard command protocol, it is necessary to have multiple scripts to allow for multiple such operations. Further, it will be appreciated that the multiple scripts will be exhausted after a same multiple of operations. In some embodiments, the scripts can be refreshed by supplying a new set of scripts to the DTC.

In one example embodiment, the MCU hosts a predefined total number of scripts (for example, 10 scripts) generated with increasing counter values, each time a script is used it is disabled by the MCU (an exhausted script). When the number of remaining unused (non-exhausted) scripts is a predefined percentage of the total number (for example, 5 scripts), the DTC can be configured to automatically contact a TSM during a next transaction to obtain fresh scripts. For example, during a payment transaction with an EFTPOS terminal the DTC attempts to communicate with the TSM through the EFFTPOS terminal to obtain scripts via the EFTPOS terminal. Scripts could also be refreshed via other types of terminal, such as ATMs, or could be refreshed via a smartphone if there is a facility to communicably link the smartphone with the DTC.

In another embodiment, the DTC can be configured to reset the script counter (authentication counter) to a value which allows the script to be reused. Typically, the reset value will be zero (0). To avoid risk of losing synchronization, the sequence counter is reset at the end of each script by using a PUT KEY Command. The PUT KEY command replaces the existing keyset a with an identical keyset with same key values. In one example implementation, the GPS PUT_KEY command resets the SSD counter to 0.

In embodiments, the at least one script is provided by a Trusted Service Manager (TSM). The scripts may be distributed by various means, such as an existing payment infrastructure including digital transaction devices, for example, Automatic Teller Machines (ATMs), and Point Of Sale (POS)/Electronic Funds Transfer at Point Of Sale (EFTPOS) terminals. The digital transaction devices may be adapted to transfer scripts to a DTC when a DTC comes into physical contact or wireless communication contact with such a device, for example, during a payment transaction.

In other embodiments, the scripts may be distributed to a DTC from a computing device (including Personal Computers (PCs), tablet computers and other kinds of computing devices), which is connected to the internet and can communicate with a DTC with a suitable peripheral device. In yet another embodiment, the scripts could be distributed to the DTC via a Data Assistance Device (DAD), such as a smartphone, a smartwatch, a fob, a smart ring and any other suitable device with computing capability and connection to a network, such as the internet for communicating with a TSM. In embodiments, the DAD and DTC are suitably configured to allow intercommunication, for example, by Bluetooth™ or other suitable communication protocols.

In one embodiment, the apparatus, the system, and/or the method is operable to perform at least one digital transaction with at least one digital transaction device, the digital transaction system including a Digital Transaction Card (DTC) including a Digital Transaction Processing Unit (DTPU), the DTPU including a software module including instruction code which, when executed, causes the DTPU to receive and implement instructions in accordance with a standard command protocol (“standard commands”); a DTC external processor; and a DTC transceiver, in which the DTPU software module is operable to receive a plurality of standard commands issued by the DTC external processor responsive to user selection of a desired DTC personality, thus causing the DTPU to adopt the user selected personality; and upon completion of execution of the plurality of standard commands, the DTC adopts the user selected personality as the personality of the DTC.

In another embodiment, the method includes operating a digital transaction system, the digital transaction system operable to perform at least one digital transaction with at least one digital transaction device, the digital transaction system including a Digital Transaction Card (DTC) including; a Digital Transaction Processing Unit (DTPU), the DTPU including a software module including instruction code which, when executed, causes the DTPU to receive and implement instructions in accordance with a standard command protocol (“standard commands”); a DTC external processor; and a DTC transceiver, the method including issuance of a plurality of standard commands from the DTC external processor to the DTPU responsive to user selection of a desired DTC personality; the plurality of standard commands causing the DTPU to activate the user selected personality; and the DTC thereby adopting the user selected DTC personality and being operable for use in a digital transaction network to effect transactions as the user selected DTC personality.

In yet another embodiment, the Digital Transaction Card (DTC), for use in a digital transaction system, includes a Digital Transaction Processing Unit (DTPU), the DTPU including a software module including instruction code which, when executed, causes the DTPU operating system to receive and implement commands in accordance with a standard command protocol (standard commands”); a DTC external processor; and a DTC transceiver, in which the DTPU software module is operable to receive a plurality of standard commands issued by the DTC external processor responsive to user selection of a desired DTC personality, thus causing the DTPU to adopt the user selected personality; and upon completion of execution of the plurality of standard commands, the DTC adopts the user selected personality as the personality of the DTC.

In yet a further embodiment, the apparatus, the digital transaction system, and/or the method is operable to perform at least one digital transaction with at least one digital transaction device, the digital transaction system including a Digital Transaction Card (DTC), including a Digital Transaction Processing Unit (DTPU), the DTPU including a software module having instruction code which, when executed, causes the DTPU operating system to receive and implement commands in accordance with a standard command structure (“standard commands”); a DTC external processor; a DTC transceiver; and a DTC user interface, in which the DTC external processor has received data pertaining to a plurality of separate DTC personalities; and stored the plurality of personalities in DTPU storage memory; and; the DTPU software module is operable to receive a plurality of standard commands issued by the DTC external processor responsive to user selection of a desired personality using the DTC user interface, causing the DTPU to activate the user selected personality; and upon completion of execution of the plurality of standard commands, the DTC adopts the user selected personality as the personality of the DTC.

In an embodiment, the method includes operating a digital transaction system, the digital transaction system operable to perform at least one digital transaction with at least one digital transaction device, the digital transaction system including a Digital Transaction Card (DTC), including a Digital Transaction Processing Unit (DTPU), the DTPU including a software module having instruction code which, when executed, causes the DTPU operating system to receive and implement commands in accordance with a standard command structure (“standard commands”) a DTC external processor, a DTC transceiver; and a DTC user interface, the method including issuance of a first plurality of standard commands to the DTPU to store data pertaining to a plurality of separate DTC personalities in DTPU storage memory, issuance of a second plurality of standard commands from the DTC external processor to the DTPU responsive to user selection of a desired DTC personality using the DTC user interface, the second plurality of standard commands causing the DTPU to activate the user selected personality, the DTC thereby adopting the user selected DTC personality and being operable for use in a digital transaction network to effect transactions as the user selected DTC personality.

In another embodiment, the Digital Transaction Card (DTC), for use in a digital transaction system, includes a Digital Transaction Processing Unit (DTPU), the DTPU including a software module having instruction code which, when executed, causes the DTPU operating system to receive and implement commands according with a standard command structure (“standard commands”), a DTC external processor; a DTC transceiver; and a DTC user interface, in which the DTC external processor has received data pertaining to a plurality of separate DTC personalities and stored the plurality of personalities in DTPU storage memory; and; the DTPU software module is operable to receive a plurality of standard commands issued by the DTC external processor responsive to user selection of a desired personality using the DTC user interface, causing the DTPU to activate the user selected personality; and upon completion of execution of the plurality of standard commands, the DTC adopts the user selected personality defined for the DTC.

In various optional embodiments, it is desirable to effect an arrangement for communication between a DTC and an external third party to communicate details of data stored within a DTC. It is further desirable for an external third party to have access to a facility to access and amend data stored on a DTC and in particular, amend the necessary data on a DTC to disable a compromised credit card or other digital transaction document that is open to fraudulent use and by amending data stored on the DTC, re-activate the compromised digital transaction document with new details that have not been compromised and hence are not subject to fraudulent use.

In embodiments, the standard command protocol is the Global Platform Standard (GPS).

In an embodiment, DTC personalities which are available for user selection are stored in an external third-party system.

In another embodiment, the digital transaction system further includes a Data Assistance Device (DAD) having access to data in the third-party system pertaining to a plurality of DTC personalities, the DAD including DAD user interface; a DAD processor; and a DAD transceiver, in which the external third-party system and the DAD are operable to transfer data from the third-party system to the DAD; the DAD and the DTC are operable to transfer data from the DAD to the DTC; and the DTPU software module is operable to receive the plurality of standard commands issued by the DTC external processor responsive to user selection of the desired DTC personality by using the DAD user interface.

In embodiments, the DAD includes a payment/card network device, such as Automatic Teller Machines (ATMs), EFTPOS, POS terminals, or the like.

In embodiments, the DAD is adapted to assist with initial setup of a DTC, including providing an MMPC to the DTC. The DAD may also be adapted for replenishing scripts to the DTC, and/or providing additional MMPCs to the DTC.

However, it should be understood that, in various embodiments implementing a DAD, the DAD is not essential for performing all operations with the DTC, as the DTC is able to operate independently of the DAD for one or more, or even all operations.

In various embodiments, the DTC is configured to enable a user to effect personality changes on the DTC without requiring connection or linking to a secondary device (for example, a Data Assistance Device (DAD) such as a smartphone). Instead, the DTC is enabled to effect changes to the DTPU (for example, and EMV chip) to cause the EMV to adopt a personality or a new personality using facilities located on the DTC itself, including the DTC external processor. In some embodiments, the DTC external processor is a Micro Controller Unit (MCU), and is loaded with firm ware and/or software configured to control the DTPU in accordance with a command protocol, such as Global Platform Standard (GPS).

In embodiments, the DTC is enabled to effect a connection with an external third party using devices such as EFTPOS/POS terminals, ATMs, or suitably secured computer devices, such as a PC operating in a bank branch, along with being enabled to effect connection with a DAD, such as a smartphone.

In some embodiments, the DTC requires connection to an external third party or a DAD when effecting a limited range of transactions, for example, when obtaining a newly-issued personality from a card issuer. The DTC may also require data and operational software or firmware from an external third party other than the data associated with a newly-issued personality, and the DTC may be operational to be connected to the third party to obtain such data.

In some embodiments, the DTC includes two or more DTPUs, wherein each DTPU is operable to allow loading of one or more files representing a personality. In such embodiments, each DTPU is operable to perform digital transactions with the respective personality when that personality is selected. In other such embodiments, each DTPU is operable to allow loading of one or more files representing more than one personality, wherein each DTPU is operable to perform digital transactions with the respective personality when that personality is selected.

In one embodiment, the present invention provides a digital transaction system operable to perform at least one digital transaction with at least one digital transaction device, the digital transaction including a Digital Transaction Card (DTC), including a Digital Transaction Processing Unit (DTPU), and a DTC transceiver, a Data Assistance Device (DAD), including a DAD user interface, a DAD transceiver, and the DAD having access to data pertaining to a plurality of DTC personalities, wherein an external third party system and the DAD are operable to transfer data from the third party system to the DAD and the DAD and DTC are also operable to transfer data from the DAD to the DTC, wherein the DTPU includes a software module having instruction code which, when executed, causes the DTPU to receive and implement instructions according with the Global Platform Standard (GPS), the DTPU software module operable to receive a plurality of GPS commands issued by the DTC external processor responsive to user selection of a desired personality using the DAD user interface, thus causing the DTPU to adopt the user selected personality and upon completion of execution of the plurality of GPS commands, the DTC operable to effect transactions as the user selected personality.

In an embodiment, the user selected personality is communicated to the DTC by the DAD. In another embodiment, the DTPU seeks a data transfer from the DAD which includes the user selection.

In another embodiment, the present invention provides a method for operating a digital transaction system, the digital transaction system operable to perform at least one digital transaction with at least one digital transaction device, the digital transaction system including a Digital Transaction Card (DTC), having at least a Digital Transaction Processing Unit (DTPU), and a DTC transceiver, the system further including a Data Assistance Device (DAD), having at least a DAD user interface, a DAD transceiver and having access to data pertaining to a plurality of DTC personalities, wherein an external third party system and the DAD are enabled to transfer data from the third party system to the DAD and the DAD and DTC are also operable to transfer data from the DAD to the DTC, wherein the DTPU includes a software module having instruction code which, when executed, causes the DTPU operating system to receive and implement instructions according with the Global Platform Standard (GPS), the method including issuance of a plurality of GPS commands from the DTC external processor to the DTPU responsive to user selection of a desired DTC personality using the DAD user interface, the plurality of GPS commands causing the DTPU to activate the user selected personality, the DTC thereby adopting the user selected DTC personality and being operable for use in a digital transaction network to effect transactions as the user selected DTC personality.

In another embodiment, the present invention provides a Digital Transaction Card (DTC) for use in a digital transaction system, the DTC having a Digital Transaction Processing Unit (DTPU), and a DTC transceiver, the DTC operable to communicate with a Data Assistance Device (DAD) having at least a DAD user interface, a DAD processor, a DAD transceiver and the DAD having access to data pertaining to a plurality of DTC personalities, wherein an external third party system and the DAD are operable to transfer data from the third party system to the DAD and the DAD and DTC are operable to transfer data from the DAD to the DTC, the DTPU including a software module having instruction code which, when executed, causes the DTPU operating system to receive and implement instructions according with the Global Platform Standard (GPS), the DTPU software module operable to receive a plurality of GPS commands issued by the DTC external processor responsive to user selection of a desired personality using the DAD user interface, thus causing the DTPU to adopt the user selected personality and upon completion of execution of the plurality of GPS commands, the DTC operable to effect transactions as the user selected personality.

In an embodiment, the system further includes a Data Assistance Device (DAD), the DAD including at least a DAD user interface; a DAD processor; and a DAD transceiver, in which the DAD is operable to receive data from an external third party; the DTC and DAD are enabled to transfer data from the DAD to the DTC; and the transfer of data from the DAD to the DTC is effected by the DAD processor and the DTC external processor and respective transceivers.

In another embodiment, the system further includes a Data Assistance Device (DAD), including a DAD user interface; a DAD processor; and a DAD transceiver, in which method the DAD is operable to receive data from an external third party; the DTC and DAD are enabled to transfer data from the DAD to the DTC; and the transfer of data from the DAD to the DTC is effected by the DAD processor and the DTC external processor and respective transceivers.

In yet another embodiment, the DTC is operable to receive data from a Data Assistance Device (DAD), the DAD including a DAD user interface; a DAD processor; and a DAD transceiver, in which the DAD is operable to receive data from an external third party, the DTC and DAD are enabled to transfer data from the DAD to the DTC; and the transfer of data from the DAD to the DTC is effected by the DAD processor and the DTC external processor and respective transceivers.

In an embodiment, the external third-party system and the DAD transfer data therebetween. In another embodiment, the DAD and the DTC transfer data therebetween.

In an embodiment, rather than transferring data to the DTPU, the DAD transfers data to the DTC external processor that is incorporated within the DTC. The DTC external processor receives data from the DAD including a request for the DTC to adopt a specific personality. In this embodiment, the DAD may transfer GPS commands to the DTC external processor for on-forwarding to the DTPU or alternatively, may transfer a request for a specific personality in an alternate format to the DTC external processor which itself generates appropriate GPS commands for transmission to the DTPU to effect the request.

In various embodiments, the DTPU includes flash memory in which memory areas can be selectively allocated to perform as any one or more of ROM, EPROM, and EEPROM.

In some embodiments, a Data Assistance Device (DAD) and a Digital Transaction Card (DTC) operating together for a digital transaction provides at least two factor verification (including authorization, authentication, and both authorization and authentication) for the digital transaction, the two factors being that the user (for example, someone wanting to pay for goods and/or services using a financial digital transaction) requires two items, namely, the DAD and the DTC. Accordingly, if a person has both a DAD and a DTC when seeking to conduct a digital transaction, the likelihood that the person has obtained both items by fraud, theft, or some other nefarious means is significantly reduced. For example, if the DAD is a smartphone, then it is unlikely that a person seeking to conduct a fraudulent transaction would be able to steal a legitimate DTC and the owner's smartphone when compared with the theft solely of a legitimate credit card. Further, if a person seeking to conduct a fraudulent transaction managed to steal a legitimate DTC, it would be very difficult for that person to emulate or spoof the DTC owner's smartphone, including any necessary additional hardware and/or software to operate with the DTC for a digital transaction.

In embodiments, the present invention provides a method of conducting digital transactions using a digital transaction system including a plurality of personalities represented by Modified Mobile Payment Cards (MMPCs) (which may also be referred to as a plurality of Logical Digital Transaction Document Packets (LDTDPs), or personalities, each personality representing a digital transaction document and including one or more of a unique IDentification (unique ID) or a token associated with the unique ID for performing a digital transaction with at least one digital transaction device, the digital transaction system further including, storage memory for personalities, a DAD, and a DTC including, a Digital Transaction Processing Unit (DTPU), and, a secure record memory, the method including, operating the DAD to select one of the at least one stored personalities operating the DTPU to access the selected one personality thus enabling the DTC to be operable as the digital transaction document associated with the selected one personality.

In some embodiments the selection of a particular personality may be effected by arranging the personalities in a particular order. Alternatively, all personalities other than the selected personality may be marked as inactive.

In various embodiments, the digital transaction document may be a credit card, debit card, bank account, store card, passport, identity card, age verification card, loyalty card, government agency card, driver's license, and/or various other kinds and types of digital transaction document, which would be typically implemented as cards, documents or booklets, or implemented electronically. It will be understood that in this specification the term “logical” refers to a set of characteristics for each of the digital transaction documents, and those characteristics may be in part or all contained in a personality representing the document or logical document. The characteristics may include data such as a unique ID for the digital transaction document, ownership information and expiry dates. The unique ID information may be a unique ID number. A change in the DTC affected by the DTPU from expressing one digital transaction document to expressing another digital transaction document may also be referred to as a change in the DTC personality.

In embodiments, a personality may include the unique ID and a token associated with the unique ID, the unique ID and token both associated with the digital transaction document represented by the LDTDP. In other embodiments, the personality may include only the unique ID associated with the digital transaction document. In yet other embodiments, the personality may include only the token associated with a particular unique ID, the unique ID (and, therefore, the token) associated with the digital transaction document.

In some embodiments, each of a number of digital transaction documents may be associated with a single unique ID and a single token associated with the unique ID, each of some other digital transaction documents may be associated with a single unique ID and a number of different tokens associated with the unique ID, and each of yet other digital transaction documents may not be associated with any token (in which case such a digital transaction document will be associated only with a unique ID). In these embodiments, the unique ID and/or token for a digital transaction document (or logical digital transaction document) will be contained in a personality. Where a document has a number of associated tokens, each token, or token/unique ID pair, may be in a separate personality. In embodiments, the unique ID for the digital transaction document contained in the personality may be a Personal/Primary Account Number (PAN) if the document is a credit/debit type card, or similar kinds of unique IDs, such as unique alphanumeric IDs or unique names.

In yet another example, a digital transaction document associated with a unique ID and multiple tokens may be represented by various personalities including both the unique ID and one of the multiple tokens, or could be represented by one personality containing the unique ID, and a number of other personalities, each containing one of the multiple tokens associated with the unique ID associated with the digital transaction document represented by all the personalities, wherein the one of the personalities being copied to secure record memory causes the DTC to operate as either the digital transaction document associated with the tokenized unique ID, or the digital transaction document associated with the untokenized unique ID.

Other arrangements for the personalities may be contemplated, depending on the nature of the digital transaction document represented by the personality (or personalities).

In some embodiments, a personality may also contain further data associated with a digital transaction document, such as an expiry date for the document. It may also be desirable in some circumstances to have multiple expiry dates in a personality, for example, one expiry date for the unique ID (or for the associated digital transaction document) and another expiry date for a token associated with the unique ID. It will be understood that, where a digital transaction document has a number of associated tokens, each token may have a different expiry date, which will be contained in the respective personality.

Further, the personality for some digital transaction documents may include a commencement date, so that the period between commencement of validity and expiry of validity of the document (and/or one or more tokens associated therewith) can be controlled. For example, it may be desirable to have the digital transaction document valid for only one day if the document is a door pass or some other card or pass with a short validity requirement. Moreover, the commencement and expiry in the personality could include times as well as dates for finer control of the validity period of the digital transaction document (and/or one or more tokens associated therewith).

In other embodiments, the further data contained in a personality may include a security code associated with the unique ID of the document, and may also include a number of other different security codes associated with one or more tokens also contained in the personality. For example, where the digital transaction document is a credit card, the security codes may be Card Verification Value 2 (CVV2) security codes, or similar. In this example, the unique ID is a PAN, which has an associated CVV2 security code, and the PAN has, perhaps, five associated tokens, each token also having an associated CVV2.

In yet other embodiments, the personality may contain a Personal Identification Number (PIN) for the digital transaction document. There may be one PIN associated with the unique ID of the document, and other (different) PINs, each associated with a token. In some embodiments, the PINs could be One-Time PINs (OTPs), which expire after being used for a single transaction. In other embodiments, the PINs may have a limited period of validity, for example, expiring one week after first use. In yet another embodiment, the DTC operates with a global PIN, which provides verification/authentication for all the digital transaction documents on the DTC.

In yet other embodiments, the DTC is capable of generating or receiving and displaying a dynamic CVV for each MMCP. A dynamic CVV may be useful for Card-Not-Present transactions.

In other embodiments, the personality may contain other data, such as name, date-of-birth, physical characteristics, and other personal data of a person who owns the digital transaction document. For example, if the digital transaction document is a passport, for certain transactions a personality containing the passport unique ID and eye color (or other biometric) of the owner may be desired for authentication and/or verification in such transactions.

The personality may be described as including, containing, wrapping or embodying a unique ID, token and/or other data. Further, the personality may be encrypted (or otherwise secured) to protect the data contained in the LDTDP. In yet other embodiments, the personality may be secured by using a public/private key infrastructure. The public and private keys may be issued by, for example, the DTC's primary issuer. Alternatively, the public and private keys may be issued by a primary issuer of a personality, for example, a credit card provider.

The DTPU may also include a processor, or Central Processing Unit (CPU), which operates to control the DPTU. Further, the DTPU may include a crypto-coprocessor for encrypting and decrypting data efficiently, thus allowing the CPU to operate more efficiently without the burden of encryption/decryption tasks. In some embodiments, the CPU and crypto-processor co-operate to decrypt (unwrap, unpack, or otherwise deal with) a selected personality, before or while being stored in secure record memory, such that the DTPU can operate with data from the personality.

The DTPU may also include various different types of memory, such as Read Only Memory (ROM), Random Access Memory (RAM), and Electrically Erasable Programmable Read Only Memory (EEPROM). Further, one of the types of memory could be used as personality storage memory.

In some embodiments, the DTPU is an EMV chip (where EMV is an abbreviation for Europay, MasterCard, and Visa) or chip conforming to one or more EMVCo specifications. In other embodiments, the DTPU is an EMV-like chip (otherwise conforming to one or more EMVCo specifications).

In embodiments, the CPU of the DTPU and or the CPU of the DTC is activated only after the CPU securely identifies itself to a linked DAD, such as a smartphone. In some embodiments, linking between the DAD (for example, a smartphone) and the DTC uses strong encryption for the ID and transfer of data. Links may be unique to each set (smartphone and DTC).

In embodiments, the linking between the DAD and the DTC is wireless, and may be formed using respective transceivers of the DAD and DTC. In yet other embodiments, the DTC is linkable with the DAD using a physical connection, such as a data cable. In such embodiments, the data cable may be adapted at one end to plug in to a USB port on the DAD, with the other end adapted to clamp or clip on to a part of the DTC. The DTC may have electrodes, or metal plates at or towards an edge thereof to connect with the cable when clamping or clipping the other end of the data cable to the DTC.

In various embodiments, the DAD is able to transfer data to the DTC without the formation of a direct link between the DAD and DTC. In such embodiments, the DAD is used to transfer data via the internet to a “cloud” connected third party device; a link between the DAD and the third-party device for the data transfer can be temporary, and that link can be terminated once the data has been transferred. In another embodiment, the third party device is connected to a network (perhaps via another third party, such as a payment processor), which enables the third party device to form a link and communicate with a digital transaction device, such as a Point Of Sale/Electronic Funds Transfer at Point Of Sale (POS/EFTPOS) terminal or Automatic Teller Machine (ATM); subsequent to forming a link with the network and thence to the digital transaction device, the third party device is enabled to transfer the data previously received from the DAD to the digital transaction device. A holder of the DTC (which may be a person different from the owner and/or operator of the DAD) can take the DTC to the digital transaction device, and by insertion or placing the DTC proximal to the device (using Near Field Communication (NFC)), the DTC holder can obtain data from the digital transaction device. In this way, the data from the DAD can be transferred indirectly and asynchronously to the DTC. This indirect data communication between the DAD and the DTC can also be reversed such that the DTC indirectly and asynchronously transfers data to the DAD, perhaps using the same infrastructure of the digital transaction device, the network including the payment processor, the third-party device and the internet. It will be appreciated that the indirect and asynchronous data transfer may be useful where a first person has a DAD and wants to send data to a DTC in the control of a second person who is geographically remote from the first person. For example, a mother operating her DAD may seek to increase spending limits of a DTC operated by her son who is travelling in a foreign country.

Similarly, in various embodiments, external parties are able to transfer data to the DAD without the formation of a direct link between the external party and the DAD. In such embodiments, the external party may transfer data via the Internet to a “cloud” connected third party device and a link between the “cloud” connected third party device and the DAD may be subsequently formed for the purpose of transferring data to the DAD. The communication link between the external party and the DAD whether direct or indirect, may be temporary and the link may be terminated once a data transfer from the external party to the DAD is complete. Similarly, the establishment of a communication link between the DAD and the DTC for the purpose of transferring data from the external party to the DTC may be formed directly and/or indirectly and may also be temporary and terminated once a data transfer is complete.

In an embodiment, external parties form a communication link with a user's DAD and transfers data that will effect an amendment to the token stored in respect of a personality. A personality's token may require updating in the event that the logical digital transaction document stored in the user's DAD has been compromised and is open to fraudulent use. In these instances, upon learning that a user's digital transaction document has been compromised, an external party can immediately transfer data to a user's DAD and when a communication link is formed between the DAD and the DTC, the token of the logical digital transaction document may be updated thereby preventing any fraudulent use of the digital transaction document. Of course, in circumstances where the DTC is not sufficiently close to a user's DAD for the purpose of establishing a communications link, the update to the logical digital transaction document token may be delayed and during that period, use of the DTC when configured with the personality of the compromised digital transaction document allows fraudulent use of the document. However, in embodiments, in order to use the DTC, the DTC must be brought into sufficiently close proximity, or take any action necessary, to form a communication link between the DAD and the DTC in order to enable the DTC to be used for a digital transaction. In this Embodiment, in the event that an updated token for the digital transaction document is required, at the time of forming the communication link between the DAD and the DTC, the token may be updated thereby preventing any use of the DTC for fraudulent purposes with the compromised token.

In embodiments, the DTC CPU controls the data reading and re-read from the DTPU (for example, an EMV chip), and updating of the DTPU.

In embodiments, a DTC includes a wearable payment device, including payment devices that are incorporated into pieces of jewellery such as a finger ring, bangles and pendants. The DTC also includes any implantable payment device, which includes chip and transceiver arrangements which may also be suitably configured for subcutaneous implantation.

In other embodiments, the DAD may be a smartphone, or another suitable device, such as a fob, or key fob, which is configured to operate as a DAD. In some embodiments, the DAD may be, or may include a wearable device, such as a watch or other piece of jewellery. In this regard, some smartphones presently operate with wearable wrist (or watch-like) devices. It is envisaged that future smartphones may be wholly incorporated into a wearable device, and that the DAD can be such a device. In the circumstance that the DAD includes a smartphone operating with a wearable wrist (or watch-like) device, it will be appreciated that the wearable component may have its own unique ID, which can be used for securing linking and data transfer between the DAD and the DTC in cooperation with unique IDs, respectively, for a smart phone and the DTC.

In other embodiments, the DAD (smartphone), after securely connecting to the DTC, uploads correctly formatted data of a personality (the MMPC) to the nominated secure storage and then transmits an instruction to either the DTPU CPU or the DTC CPU to check if the nominated storage area contains the data in a specified format (a compliant personality). If the data meets the specified format and passes various checks, the DTPU CPU or the DTC CPU copies or moves the data (LDTDP) to a specified area (secure record memory/secure element) within the DTPU (for example, within the EMV chip). In an alternative embodiment, the personality is copied or moved to a location within a secure application. The DTPU CPU or the DTC CPU then transmits an instruction to the DTPU (EMV chip) to read the data (LDTDP) within the secure record memory and acts according to the data (express the personality as the associated digital transaction document) contained within this secure record memory (secure element). The DTPU CPU or the DTC CPU can be instructed to search for identifying headers and other data identifiers within a range of parameters before acting.

In some embodiments, the secure record memory (secure element) is located in the DTPU, and the personality storage memory (storage memory or a memory location) is located on the DAD. In other embodiments, the secure record memory (secure element) could be located within the CPU. Further, the personality storage memory could be located outside of the DTC, for example, as additional memory located on the DAD. It is also conceivable that the secure record memory (secure element) could be located outside of the DTPU on the DTC, however, this may be less secure than locating the secure record memory within the DTPU. In yet other embodiments, the personality storage memory could be located elsewhere other than the DAD or the DTC, and, for example, the personality storage memory could be located in a cloud based storage system, or could be located on portable memory, which can be accessed from the DAD.

In embodiments, the DTC includes a card transceiver. In other embodiments, the DTC includes a Graphical User Interface (GUI) for displaying data associated with the digital transaction document or token associated with the selected or implemented personality. For example, if the logical digital transaction document is a credit card, the GUI on the DTC may display the PAN, the selected token associated with the selected personality containing the logical digital transaction document, the card brand logo, the expiry date of the credit card, and could also display a virtual or mimicked hologram of the credit card brand. In another embodiment, the DTC may only display the selected token and not the associated PAN. The DTC may also include a real hologram displayed somewhere on its surface.

The DTC may also include a processor or CPU for controlling operations external to the DTPU and/or for controlling reading/writing and other input/output operations with the DTPU via the DTPU system I/O. The DTC CPU may also accommodate security tasks external to the DTPU, and/or control the GUI. In some embodiments, the DTC may include firmware operated by the CPU of the DTC. In embodiments, the firmware on the DTC CPU may be updated and the DTC is provided with means for enabling firmware updates. The updates may include firmware that extends functionality of the DTC and any programs and/or applications running thereon. The updates may allow for correction or amendment of existing firmware functions that have been identified as faulty or sub-optimal. Other firmware updates may improve or extend security, or secure functioning of the DTC. The ability to update firmware may be contrasted with, for example, existing credit or debit cards using EMV chips, where there is no ability or limited ability to update the EMV firmware.

Presently, firmware is “updated” by replacement of a credit card or debit card when it expires. In the circumstances that the DTC has a relatively long operational life, for example, 5 years or more, updating firmware during the operational life of a DTC enables the functionality of the DTC to be improved or enhanced without requiring return of the DTC to the issuing authority.

In embodiments, the DTC may only form a communications link with one DAD to the exclusion of all other DADs representing a secure communications link and transmission of data between the DAD and the DTC by respective transceivers (the DTC transceiver and the DAD transceiver). In some embodiments, the link is a secure/encrypted link. In other embodiments, each DAD may be linked with multiple DTCs. However, in this embodiment, each DTC may link with only one DAD, to the exclusion of all other DADs.

In embodiments, the linking between the DTC and the DAD may be implemented by using a unique identifier for the DTC and another unique identifier for the DAD. In some embodiments, the linking of the DTC and the DAD may occur (at least partially) before the DTC is sent to a user, for example, the linking may be implemented by a DTC issuer, including a bank, a card issuing facility, a card “personalization” facility, or other type of third party institution capable of implementing a “partial-linking”. In one example, a partial linking may be implemented by the DTC issuer establishing the DTC and providing an application ready for download by a user to the user's DAD (for example, a smartphone), wherein activating the application causes the smartphone to look for, and link to, the DTC issued to the user. In other embodiments, the linking may be implemented by the user, and may occur when the user receives the DTC.

In some embodiments, the linking between the DTC and the DAD is permanent, or semi-permanent, and cannot be unlinked, or re-linked without permission and required action from, for example, one of the previously-mentioned third parties. For example, to unlink a DTC and the DAD uniquely linked to it, a unique code may be entered on the DAD and uploaded to the DTC. This will reset the DTC to a default state. In the default state, the DTC could “look” for a new specified unique identifier for a different DAD (for example, an NEI number, or another suitable unique ID, of a smartphone). This unlinking/re-linking may be useful when the user replaces their DAD, such as a smartphone. In yet other embodiments, the linking may be temporary, and performed by the user. For example, a user may form a link a short time before an intended transaction is to occur, and, may unlink after the transaction is completed at a predefined short duration after the transaction.

In an embodiment where the DTC and the DAD are dynamically linked (that is, linked by the user at a chosen time), the linking and selection of the desired personality from the DAD can occur in any order.

In embodiments, in order to ensure secure communication between the DTC and the DAD, the security may be implemented by linking the transaction card and the DAD, or the security may be implemented during data transmission between the transaction card and the DAD. In other embodiments, the security may be implemented during both the linking and the data transmission.

In some embodiments, the DTC includes a battery or capacitor to provide electrical power for memory storage, for example, if the card includes non-static type memory storage or, some form of powered transceiver, such a as Bluetooth™ transceiver. A battery can also be used to power the DTC to process encryption, and for changing the personality containing the digital transaction document and/or digital token expressed by the DTC by implementing changes in the personality containing the logical digital transaction document and/or the associated digital token.

In some embodiments, the DAD includes a processor, a user interface, a device transceiver and device memory. In various embodiments, the DAD may be a smartphone, computer tablet, laptop, Personal Computer (PC), fob device, or other suitable equipment capable of operating to allow a user to select a personality and transmit data representing that selected personality. The DAD may also be a custom-built device suitable for the purpose. In other embodiments, the DAD may be a wearable device, such as a smart watch, or could be enabled to operate with such a wearable device.

In an embodiment, a selection is made from the user interface of the DAD, which may include selecting from a touch activated screen, for example, on a smartphone. The touch activated screen may operate by displaying lists, drop-down lists, or other screen designs, or may employ icons on the screen. In an alternate embodiment, the user interface may be a simple display with buttons, for example, on a fob, or a key fob. Where the DAD is a PC or laptop, it may employ a screen and keyboard to provide a user interface. However, the DAD is generally preferred by users to be a portable device. On the DAD screen, a personality may be represented symbolically with an icon relevant to the associated (logical) digital transaction document, or could use names or nicknames for the personality. The names or nicknames could be assigned by the user, or a service provider.

For example, the document might be a MasterCard credit card, so that the personality associated with the MasterCard is represented on the DAD screen by a MasterCard logo. Additionally, or alternatively, the personality may be represented by a combination of icon and alphanumeric information. For example, where a MasterCard has one or more associated tokens, each token contained in a separate personality, the personality for each MasterCard token may be represented on the DAD screen by the MasterCard logo and at least a part of the respective token number.

In some embodiments, the at least one of the plurality of personalities is stored on the DAD, wherein the personality storage memory is located on the DAD. In other embodiments, the at least one of the plurality of personalities is stored in personality storage memory located on the DTC, wherein selection of a personality through the DAD is effected by an icon, name or other indicator associated with the LDTDP, although the personality is not itself stored on the DAD. In this example, the selection of the personality is communicated to the DTC by data indicating which personality has been selected, and the card implements the selected personality from its personality storage memory based on the indicative data.

In yet other embodiments, a part of each of the at least one of the plurality of personalities is stored on the DAD. Another part of each corresponding at least one personality is stored on the DTC, wherein the selection is based on the part stored on the DAD. The part of the personality selected is transmitted to the DTC, and the determination of which part of the personality matches the selected part is made on the DTC in this way, the two parts of the personality can be combined to form the whole personality, which can then be implemented by the DTC. In such an embodiment, the personality storage memory is split between the DAD and the DTC.

In an embodiment, the DAD is enabled to store and provide for selection of a personality, which is implemented as a digital transaction document on the DTC. The selection of the document associated with a personality (or selection of the personality) may occur before selection of a token associated with the personality. Where a document has only one associated token, the selection of the document may be selection of the associated token, since a further selection process is not required. In some embodiments, selection of a token automatically indicates which personality is to be selected, since the token is associated only with one document (or one personality).

In another embodiment, the user may select a personality and a predetermined token is selected based on context determined by the DAD. For example, if the DAD senses different locations, then a token can be automatically selected based on the sensed location.

In various embodiments, some digital transaction documents contained in a personality will have only one associated token and other digital transaction documents will have multiple associated tokens. It will be understood that embodiments discussed in this specification include both options, unless otherwise stated or unless the inclusion of both options results in an embodiment that is not possible to implement.

In various embodiments, identifying information in respect of a digital transaction document contained in a personality will not need to be stored in the system personality storage memory (either in the device memory or the card memory) since the token(s) stored in the system will be sufficient to identify its (their) associated digital transaction document(s). For example, where the digital transaction document is a credit card, the card number (the PAN) is not contained in the personality and instead, the tokens associated with the credit card are sufficient to identify the particular credit card. In such an example, the credit card PAN may include the typical 4 leading digits which identifies the card as being of a certain type or brand (MasterCard, Visa, etc.). In other examples, only the last 4 digits are displayed. A token for the particular credit card may have the same four leading digits, but with different remaining digits, so that the token identifies the card with which it is associated. It will be appreciated that not having a PAN, for example, contained in the respective personality and stored in the system personality storage memory (either in the DAD memory or the DTC memory) increases security for the associated digital transaction document. In such examples, only the digital token containing personalities are selected by the DAD, with the associated digital transaction document being automatically identified and selected.

In various embodiments, the digital transaction devices may include POS/EFTPOS terminals, ATMs, internet connected computers or personal computers, and other such electronic devices. The digital transaction device may also include infrastructure such as a telephone and call centre enabled for Mail Order/Telephone Order (MOTO) type transactions.

In various embodiments, The DTC may also include a switch, or a similar device, to activate linking with the DAD. In some embodiments, the respective transceivers for the DAD and the DTC may be suitable for Bluetooth™, Low Energy Bluetooth™, Wi-Fi, NFC, ANT+, or other types of contactless, or wireless communication transceivers. In other embodiments, the transceivers may require contact between the DAD and the transaction card in order to transmit data, or in order to establish a link therebetween.

In an embodiment, the DTC may be adapted to express a default “null” personality, wherein the data in place of a personality containing a logical digital transaction document requiring unique identification could be a predetermined series of digits, for example, all zeros. In one example, where the logical digital transaction document represented by the personality is a credit card, the unique identification may be the credit card PAN or an associated digital token, and setting the DTC back to expressing a null personality is performed by over-writing or replacing the PAN or the associated digital token with all zeros.

In an optional embodiment, the DTC may be configured to store a personality for an associated logical digital transaction document and/or associated digital tokens for a chosen period. The period may be predetermined by the issuer of the DTC and/or issuer of the digital tokens (which may be a different issuer to that of the DTC). Alternatively, the storage period may be chosen by the user. In other variations, the period may be dynamically selectable, and could be chosen by the user for each transaction, or for each selection and storage of a single personality for an associated logical digital transaction document and/or associated digital token(s) on the DTC. In other embodiments, the storage period for the personality for an associated logical digital transaction document and/or associated digital token(s) on the DTC could be determined based on the personality selected, the transaction type, or both.

In embodiments, the DTC and the digital transaction device may interface with each other by various methods. In some embodiments, the interface may be effected by insertion of the DTC into the digital transaction device. In other embodiments, the interface between the transaction card and the transaction device may be effected by Near Field Communication (NFC), wherein the card and/or the device each have a transceiver and antenna for communication. In yet other embodiments, the DTC may include a magnetic stripe, wherein the digital transaction device includes a magnetic stripe reader. In yet other embodiments, the DAD may include a transceiver configured for communication with the digital transaction device, so that transactions can optionally be made directly through the DAD. In yet other embodiments, the DTC is configured to be inserted into a POS/EFTPOS terminal, or an ATM, and is approximately the same size as a credit/debit card.

In further embodiments, the DTC may have a magnetic stripe, and the DAD may have a magnetic stripe reader and/or writer.

In yet another embodiment, the DTPU of the DTC is configured to store/express the personality associated with only one personality containing a logical digital transaction document and associated digital token(s) at any particular time. In this regard, to change the personality in the DTPU, a user must overwrite, delete, or render inactive, a previously-stored/expressed personality containing a logical digital transaction document and its associated token(s) if there is one embodied in the DTC at that time. In another embodiment, the card may be configured to store/express more than one personality (containing a logical digital transaction document and the associated token(s) for each document) concurrently.

In another embodiment, the DTC and its DTPU may be configured to store and/or express a personality associated with a primary logical digital transaction document and its associated token(s), and one personality associated with a secondary logical digital transaction document and its associated token(s). In yet another embodiment, the DTC and its DTPU may be configured to store and/or express one personality associated with a primary logical digital transaction document and its associated token(s), and one or more personality associated with secondary logical digital transaction documents and associated token(s) for each. The personality associated with the primary logical digital transaction document (primary logical card) and its associated token(s), in some embodiments, may be stored permanently on the DTC in its DTPU, with the one, or one or more, personalities associated with secondary logical digital transaction documents (logical cards) and the associated token(s) for each being temporarily stored on the DTC in its DTPU. In yet other embodiments, the one, or one or more, personalities associated with secondary logical digital transaction documents and the associated token(s) for each may be permanently stored and/or expressed on the DTC in its DTPU and referenced by a code stored on the DAD.

In yet other embodiments, the DAD may include an e-wallet, which can be configured to operate with one or more of the personalities containing logical digital transaction documents and associated token(s) stored on the DAD. This arrangement can be used to top up funds where the associated digital transaction document is a debit card or a credit card. Further, the DAD may include functionality to allow a user to view transactions that are completed with the DTC (or by other means, such as online transactions) in real time. This may allow the user to monitor all transactions made by all personalities associated with digital transaction documents in the system (which may include a plurality of DTCs linked or linkable with the DAD) in, a single screen or with a single smartphone application. Further, the user could be shown the associated digital token that was used for a transaction. This may further allow the user to cancel, stop, pause or otherwise appropriately deal with one or more digital transaction documents if the user detects or perceives that one or more digital transaction documents have been misused or fraudulently used. The system could also be adapted to allow the user to cancel, stop, pause or otherwise appropriately deal with one or more digital transaction documents on a token-by-token basis, so that only certain tokens associated with a document are disabled, but the document is still useable with other associated tokens. The user could also cancel, stop, pause or otherwise appropriately deal with one or more logical digital transaction documents if the user seeks to limit, for example, spending, or other financial or non-financial transactions occurring with one or more logical digital transaction documents. This may also be performed on a token-by-token basis.

In another embodiment, the DAD may be enabled to send alerts to the user when a transaction, or a selected category or type of transaction, is conducted using the DTC. For example, the DAD may alert the user that a personality containing a digital transaction document, such as a passport, has been used for identification at an airport. Further, the alerts can be implemented on a token-by-token basis. In another example, the DAD may alert the user that a credit card has been used to purchase services such as a taxi ride, not included in a list of authorized transaction categories, such as purchases of fuel and groceries, selected by the user.

In other embodiments, the DAD and/or the DTC may be configured to allow a user to classify transactions into categories. The categories could be predefined and/or defined by the user. The categorization could be configured in order to allow the user to monitor and/or limit transactions, such as spending with credit within that category. A category may be related to only one personality and associated (logical) digital transaction document, or could be related to a number of personalities and respective associated (logical) digital transaction documents. Tokens can also be used for categorization of transactions using the one personality and associated digital transaction document.

In yet another embodiment, the DAD may be configured to allow the user to transfer funds to another user who has a DAD. The transfer may be limited to same or similar personalities and associated (logical) digital transaction document types, and could be limited in amount. In a further embodiment, the DTC could be configured to transfer funds to another DTC (owned by the user or owned by another user), or to another DAD (owned by the user or another user).

Furthermore, in another embodiment, third parties, such as financial institutions, police, customs, government, employers, spouses, parents and other interested parties could be authorized and enabled to cancel, stop, pause or otherwise appropriately deal with one or more personalities containing logical digital transaction documents in the system or selected token(s) associated with the document. This may be useful, for example, if a user has a gambling addiction, and prefers to have a third-party monitor and prevent access to credit cards, debit cards, bank accounts or other kinds of financial logical digital transaction documents in order to prevent the user from excessive gambling.

In other embodiments, the DAD may be configured to store data representing loyalty points, frequent flyer points, or other associated transaction related documents, attached to a (logical) digital transaction document contained in a personality, or plurality of (logical) digital transaction documents contained in respective personalities. The DAD may also be enabled to update loyalty points, frequent flyer points and other associated transaction related documents during or after a transaction, or at other times. For example, loyalty points may be used during a transaction to reduce the cost of an item to be purchased using the DTC and the DAD. The DAD may also be enabled to add loyalty points, frequent flyer points and other associated transaction related documents if a user visits a particular shopping store, or is in a predetermined proximity of the store. In some embodiments, the loyalty points, frequent flyer points and other associated transaction related documents may be contained in a personality as further data associated with the relevant (logical) digital transaction document and/or associated tokens.

In yet another embodiment, if the DTC includes a personality containing a primary logical digital transaction document, for example, permanently stored and/or expressed on the DTC in the DTPU, the primary logical digital transaction document may be a false or fake logical digital transaction document, such that data copied from the DTC or DTPU where only the primary logical digital transaction document is stored on the DTC or DTPU will be useless for any digital transactions. Alternatively, the primary logical digital transaction document may be represented by a unique ID that is incomplete, expired or all zeros, such as a null ID. For example, where the primary digital transaction document is a credit card, the PAN of the card could be incomplete, expired or all zeros. In this embodiment, only personalities containing secondary logical digital transaction documents stored on the DTC and/or in the DTPU will be real and useable for a digital transaction when embodied on the DTC via the DTPU as a digital transaction document. Further, a personality containing a secondary logical digital transaction document and its associated digital token(s) may be stored or embodied as a tokenized digital transaction document on the DTC and/or expressed in the DTPU for only a short period, for example, five minutes, in order to reduce the risk of theft of data representing the digital transaction document and token. This arrangement reduces the risk that an unauthorized user can emulate the associated digital transaction document and token. Alternatively, the personality containing the primary logical digital transaction document stored on the DTC and/or expressed in the DTPU may comprise incomplete data, rendering the DTC/DTPU unusable for digital transactions until a user downloads and saves secondary data to the DTC/DTPU (along with associated token data), to render the primary logical digital transaction document (primary logical card) complete and useable for digital transactions.

In yet another embodiment, each of the personalities or sub-set thereof, stored on the DAD may have a PIN associated therewith (or contained therein). The PIN may be a static PIN, or could be a dynamically generated PIN. In other embodiments, the PIN may be displayed on the user interface of the DAD. Access to the PIN to display on the screen of the DAD may be by secured methods, such as finger swipe or other such security methods such as those commonly implemented on smartphones. In another embodiment, the DAD may be configured to allow the user to update a PIN for a particular personality or for a number of personalities. In embodiments, PINs could also be associated with particular tokens for a document in a personality, such that each token for the document has a different PIN.

In an embodiment, the method includes operating the activated DTC with the digital transaction device to perform the digital transaction.

In some embodiments, tokens are provided for a personality associated with a primary logical digital transaction document before the DTC is issued to a user. The tokens can be sent to the DAD through a secure network so that a token can be selected for a transaction with the associated personality for the logical digital transaction document (already stored on the DTC or in the DTPU at issuance) at the time of a transaction. Alternatively, the tokens associated with the primary document could be loaded onto the DTC or DTPU at issuance, with selection effected by the DAD at the time of a transaction. Secondary logical digital transaction documents (optionally contained in personalities) may be issued to the user through a secure network means to the DAD after issuance of the DTC, and the associated digital tokens for each secondary document can be issued with the associated secondary document (also optionally contained in the respective personalities).

In yet another embodiment, tokens contained in one or more personalities can be a fixed or extendible pool, which are used in a cyclical manner, with a next token selected in order. Alternatively, tokens could be selected from the pool randomly (or pseudo-randomly). In a further embodiment, tokens could be one use only, with a pool of used or expired tokens replaced when every token in the pool has been used or expired. It is also possible that the pool of tokens is replenished in advance of every token being used or expired, for example, when there are ten unused or unexpired tokens remaining in the pool, the user could be alerted to the need for token replenishment. It will be understood that single use tokens can improve security for an associated digital transaction document (and its containing personality file), and for the transactions. In another embodiment, the user could choose when to replace tokens in the token pool. In this embodiment, the user could request a new pool or an extension of their existing pool of tokens from a token provider. The new tokens could be provided already contained in respective personalities for storage in personality storage memory.

In a further embodiment, a primary user of a given digital transaction document could assign tokens to a secondary user of that document. For example, a primary credit card holder could assign token(s) from a token pool to a subsidiary holder of that credit card. This may be used as a way to control the spending of the subsidiary credit card user to limits, amounts or categories of spending.

In yet other embodiments, where tokens are assigned for usage in only certain transaction types, a third party, such as a token issuer, government agency or other controller of token usage, has authority to allow issuance of only tokens for selected transaction types. In one example, the authority controlling issuance of tokens may only allow tokens to be issued for a credit card that are for non-gambling expenditure.

In some embodiments, the tokens are generated only by a third-party provider who issues the tokens to users (optionally already contained in respective personalities). The tokens may also be issued by another third-party provider in other embodiments. Alternatively, in an embodiment, the tokens may be generated locally by the user, for example, by the DAD and stored into the personality storage memory contained in personalities. The locally generated tokens could be securely copied to a third party to be matched during a transaction to thereby authorize the transaction. A cryptogram may be created containing a token, along with one or more of the associated document's unique ID, expiry date, unique ID of the DAD, time, date, location, and various other random, pseudo-random or non-random inputs. A cryptogram may also be created using, for example, a public key from the DTC, a public key from the personality (for example, if it is a credit card personality), and/or a public key from the digital transaction device (for example, a POS/EFTPOS terminal). The cryptogram may also be created using public keys from other sources. A cryptogram created using one or more public keys will contain the one or more tokens, and other IDs and data.

In embodiments, the DTC is in the form of a wearable device including a watch (smartwatch), a ring, or could be a smartphone case. With a smartphone case, all communications occur in accordance with contactless close proximity communication according ISO/IEC 14443.

In embodiments, a mobile card application may be installed onto a smartphone to effect the functionality required for the smartphone to be able to communicate with a DTC and any external third parties who seek to communicate with a DTC through a DAD in the form of a smartphone. Once installed, the smartphone displays a login screen wherein the user is required to enter identification identifying information or credentials such as a Personal Identification Number (PIN) as required on the login screen or alternatively, any secure login arrangement such as a biometric in the form of a fingerprint as displayed on the smartphone screen. Once the user has entered a valid PIN or biometric detail, the mobile card application enables the user to operate the smartphone to communicate with a DTC and/or any interested authorised external third parties.

In various embodiments, the user is requested to place their DTC in close proximity to the smartphone. In such embodiments, the DTC is in the form of a physical card and upon bringing the DTC into close proximity with the smartphone, the smartphone display indicates the current status of the DTC. The smartphone screen indicates to the user that the DTC is disabled and has a null personality.

In some other embodiments, the user operates the mobile card application and is presented with a series of screen images on their smartphone identifying the various transaction documents that the user can select for the purpose of the DTC adopting for a particular transaction. In these embodiments, the various screen images relate to a range of accounts with accompanying transaction documents belonging to the user including, a personal Visa, a business MasterCard, a home renovations account and an option to disable the DTC and render a null personality. In the particular instance of a user selecting a business MasterCard account for the purpose of conducting a transaction, a sequence of screen images would be presented to a user. In one example implementation, in the first instance, a screen image is presented to the user requesting them to place their DTC in close proximity with the smartphone such that the contactless close proximity communication capabilities of both the smartphone and the DTC may be activated for the purpose of communication therebetween. Once the DTC is brought into close proximity with the smartphone, the user selects their business MasterCard account and upon selecting that account, relevant data is communicated between the smartphone and the DTC such that the DTC adopts the personality of the user's business MasterCard at which point the DTC for all intents and purposes behaves as a MasterCard until such time as the DTC either is selected to adopt an alternate personality or a null personality to disable the card from effecting any transactions.

In another example implementation, a DTC in the form of a physical card may be activated as a business MasterCard and is used in conjunction with a merchant terminal to effect a transaction. The merchant terminal is operably connected with an acquirer who in turn may communicate with a token provider for the purpose of converting a tokenised PAN to the PAN that is recognised by the transaction network and subsequent to which communication occurs with the card issuer. In some embodiments, a screen image is displayed on a user's smartphone to confirm that a transaction has been requested. For example, a screen image confirms to the user that a transaction has been requested with the user's business MasterCard and in this particular embodiment, the user is afforded an opportunity to approve or decline the transaction.

Whilst it is possible to develop a DTPU with hardware and firmware that is adapted to enable a DTC comprising a DTPU to adopt one of many available personalities, it is preferable to achieve the same result with an existing, certified DTPU, such as a device certified in accordance with the EMVCo specifications, without requiring any alteration to the DTPU. As will be appreciated by skilled readers, avoiding the requirement to certify a newly developed DTPU has the benefit of avoiding a substantial cost associated with the certification process and avoids the substantial delay also associated with such a process.

In the instance of credit cards, and in particular those implemented with an EMV device as the DTPU, various actions in accordance with available certified commands are implemented during the initialisation phase of a card at a fabrication facility. At that time, commands are issued to the EMV device to securely write data to the EMV secure memory thereby establishing a fixed “personality” for the card after which a security fuse is destroyed to render the secure memory “read” only.

Devices such as EMV devices operating with an operating system such as the MULTOS or JavaCard systems, allow the secure execution of application software that is installed within the EMV subsystem. EMV subsystems are considered sufficiently secure to allow third party software to be installed and operated within the EMV subsystem since the operating system will prevent any inappropriate alteration of the EMV device secure memory.

Accordingly, by retaining write access to the secure memory of the EMV device, and installing application software in the EMV system that operates to receive commands that are already available according to the current EMV subsystem, further additional functionality beyond that provided by standard DTCs can be achieved. It will be recognised by skilled readers that installation of application software affords significant additional flexibility although additional functionality can be achieved solely by using the existing command set of EMV devices whereby write access to the secure memory has been retained subsequent to encapsulation and issuance of the card to a user. In the embodiment(s) described in FIG. 5 onwards, the DTPU is implemented in the form of an un-modified EMV device according to the EMVCo specifications.

In embodiments, there is a connection between an external contact plate that is provided to effect communication between transaction devices (such as EPTPOS terminals and ATM machines) and the EMV device and the connection(s) between the external contact plate and the internal contact plate that is presently included in most, if not all, digital transaction cards that include an EMV device.

In this regard, the provision of an external contact plate and an internal contact plate is an artefact of the manufacturing process for digital transaction cards that include an EMV device and in embodiments of the present invention that include both an external contact plate and an internal contact plate, the opportunity exists to route electrical connections between the external contact plate and the internal contact plate in an arrangement other than a direct one to one connection between corresponding electrodes of the external contact plate and the internal contact plate.

In an embodiment, the electrical connections accessible to digital transaction devices by way of the external contact plate are connected to an arbitration device and depending upon the state of the arbitration device, individual electrodes of the external contact plate may be electrically connected by the arbitration device to their counterpart electrodes of the internal contact plate.

In order to provide a direct connection between counterpart electrodes of the external contact plates and the internal contact plates, the arbitration device operates to connect electrodes identified (as will be understood by a skilled reader) as GND, Vcc, RST, CLK (674), I/O and the blank terminal such that all are connected respectively to their counterpart connection of the internal contact plate such that the aforementioned electrodes of the external contact plates would be connected respectively to GND, Vcc, RST, CLK, I/O and blank terminal.

Accordingly, in embodiments, when in an appropriate state, the arbitration device would operate to connect the individual electrodes of the external contact plate directly to their counterpart terminal of the internal contact plate which in turn are connected to the appropriate connection points of the EMV device to enable the EMV Device to operate with digital transaction devices. In this configuration, the EMV device would operate normally with digital transaction devices interfacing with individual electrodes of the external contact plate and any electrical signals applied to any one of the external contact plate electrodes, namely, GND, Vcc, RST, CLK, I/O and blank terminal would pass through the external contact plate electrode through the arbitration device and pass directly to the counterpart electrode of the internal contact plate namely, GND, Vcc, RST, CLK, I/O and blank terminal.

However, in embodiments where communication between a microcontroller unit and the EMV device is required, the arbitration device adopts an alternative state and connects the data and control signal lines of the microcontroller unit through the arbitration device to the individual electrodes of the internal contact plate which in turn are connected to the appropriate I/O and control lines of the EMV device. Accordingly, the arbitration device, in the embodiment, acts as a collection of single pole double throw switches to either connect the microcontroller unit to the electrodes of the internal contact plate and thus the relevant connections with the EMV device or alternatively, when switched to its alternate mode, the arbitration device disconnects any connection between the microcontroller unit and the EMV device and connects the external contact plate electrodes to the counterpart electrodes of the internal contact plates which in turn are connected to the appropriate connections of the EMV device.

Operationally, when implementing a DTC with an arbitration device as described above, any communication between the microcontroller unit and the EMV device would need to occur at a time that the user of the digital transaction card did not require, or attempt, a transaction with a digital transaction device such that signals were applied to the electrodes of the external contact plate. Of course, if a digital transaction was either prevented, or terminated, as a result of the arbitration device switching to an alternate state such that connection between the external contact plate electrodes and the relevant connection points of the EMV device were no longer present, the digital transaction would likely terminate and would fail to execute. Whilst such an outcome may be acceptable to a financial institution with which the user was attempting to conduct a digital transaction, it is unlikely that users would consider such an interruption acceptable and it is preferable that the arbitration device were unable to interrupt communications with a digital transaction device that is communicating with the EMV device. Further, any potential interruption to data flow in the “transaction path” of devices can lead to a requirement for the device, or component, to require re-certification. As previously mentioned, the process of re-certification of a component for operation in an electronic digital transaction network can be time consuming and expensive and is preferably avoided.

In an alternative to the embodiment, the arbitration device solely controls the connection of the microcontroller unit with relevant electrodes of the internal contact plates and thus relevant signal connection points of the EMV device. In this particular embodiment, the external contact plate electrodes remain directly connected to their counterpart electrodes of the internal contact plate at all times and remain connected irrespective of the state of the arbitration device. In this particular embodiment, the arbitration device acts as a series of single pole single throw switches since it is only operable to connect single lines from the microcontroller unit to electrodes of the internal contact plate and thus signal connection points of the EMV device. In this embodiment, it is necessary to consider the possibility of electrical signals being applied to the electrodes of the external contact plate during periods in which the arbitration device has connected the microcontroller unit to the EMV device. It will be understood by skilled readers that it is possible to employ various hardware configurations to ensure that electrical signals that could potentially damage a device are prevented from reaching the device. In an embodiment, appropriate hardware elements are employed to divert inappropriate signal energy applied to electrodes of the external contact plate such that they are prevented from transmission to the EMV device and the arbitration device or the microcontroller unit. An additional issue to consider is the potential for communications between the microcontroller unit and the EMV device to be monitored, and/or interfered with, as a result of connecting a device to the external control plate and in this instance, it is expected that embodiments so configured would encrypt any communications between the microcontroller unit and the EMV device to thwart any attempt to monitor, or interfere with, such communications by accessing the signals passing between the microcontroller unit and the EMV device from the external contact plate electrodes.

In yet another alternative arrangement of connection between the microcontroller unit and the EMV device wherein the arbitration device connects and/or disconnects selective electrodes of the external contact plate with the internal contact plate. The electrodes GND, and RST are connected to the arbitration device and the arbitration device is operable to connect those electrodes of the external contact plate with their counterpart electrodes in the internal contact plate, namely, GND and RST. Accordingly, the electrodes that are not connected to the arbitration device of the external contact plate include electrodes Vcc, CLK and I/O. These particular electrodes are directly connected to their counterpart electrodes in the internal contact plates, namely, Vcc, CLK and I/O and remain connected at all times. Only selected electrical connection points of the microcontroller unit are connected to the arbitration device for switchable connection to electrodes of the internal contact plate. The microcontroller unit has permanent connections with various electrodes of the external contact plate, namely GND, Vcc and CLK. Similarly, the I/O electrode of the external contact plate and the internal contact plate are permanently connected to each other and the serial I/O communication connection point of the microcontroller unit. Such an embodiment has the advantage of reducing attempts to monitor communications between the microcontroller unit and the EMV device by accessing electrodes of the external contact plate but suffers the disadvantage that some parts of the transaction flow are interrupted by a switchable device, namely, the arbitration device and hence, recertification of the device embodied in the DTC may be required.

In a further alternative embodiment, the connection between the MCU and the EMV includes an external Vcc detection circuit which acts to detect the presence of electrical power connected to external contact plate electrode Vcc which would indicate the connection of the external contact plate with a digital transaction device for the purpose of conducting a digital transaction. In this embodiment, the external contact plate electrode Vcc is connected to the microcontroller unit through an external Vcc detection circuit such that the microcontroller unit can receive a signal confirming that electrical power has been applied to external contact plate electrode thus indicating the insertion of the digital transaction card into a digital transaction device (e.g. an EFTPOS terminal or an ATM). In this embodiment, selected electrodes of the external contact plate, namely, the GND electrode and the RST electrode are connected to independent switchable devices which can connect those electrodes to either the micro controller unit or their counterpart electrodes in the internal contact plate, namely, GND electrode and RST electrode respectively. This embodiment has the advantage of providing microcontroller unit with a signal from the external Vcc detection circuit indicating that the user has elected to conduct a digital transaction and hence, the MCU can cease its communication with the EMV device in order to allow a digital transaction to be completed by the user and subsequently resuming communication between microcontroller unit and the EMV device upon detection of the absence of electrical power connected to the Vcc electrode of the external contact plate. It will be recognised by skilled readers that a Vcc Detection Circuit could be used in any embodiment to provide an indication to the microcontroller unit that power has been applied to the Vcc electrode thus indicating insertion of the DTC into a transaction device.

In yet a further embodiment, the external contact plate electrodes are directly and permanently connected to their counterpart electrodes of the internal contact plate and at the same time are permanently connected to appropriate signal lines of the microcontroller unit and the EMV device. In this particular configuration, the electrodes of the external control plate and internal contact plate are permanently connected with both the microcontroller unit and the EMV device thereby requiring any communication between the microcontroller unit and EMV device to be encrypted to thwart any attempt to monitor, or interfere with, communications between the two devices by accessing the electrodes of the external contact plate. Whilst this particular embodiment has the disadvantage of requiring encryption of all communications between the microcontroller unit and the EMV device, it does embody the advantage of avoiding any interruption to the existing transaction flow that would occur with a EMV device when taking part in a digital transaction and hence should avoid any need to re-certify the EMV device when incorporated in a Digital Transaction Card with communication effected between the microcontroller unit and the EMV device.

In yet a further alternative embodiment for effecting communication between a microcontroller unit and EMV device, the individual electrodes of the external contact plate are directly and permanently connected to their counterpart electrodes of the internal contact plate which in turn are permanently connected to the relevant electrical connection points of the EMV device. However, in order to effect communication between the microcontroller unit and the EMV device, each device is provided with its own antenna, namely, EMV device antenna and MCU controller antenna. Both the EMV device and the microcontroller unit have their own RF communications circuitry incorporated into the respective device such that each device can communicate wirelessly. In an embodiment, the EMV device and the microcontroller unit are equipped with RF communication circuitry that can be electrically attached to an antenna and can communicate in accordance with the NFC communications protocol. In this instance, the EMV device and microcontroller unit effectively communicate with each other by NFC communications conducted on the digital transaction card. Of course, in this embodiment, it is necessary to encrypt any communication between the EMV device and the microcontroller unit in order to avoid external third parties monitoring those communications by use of an NFC receiving device but as for various of the aforementioned embodiments, there is no potential interruption to the transaction flow that would usually occur between an external contact plate and an EMV device and hence, re-certification would likely be avoided with such an embodiment for effecting communications between an EMV device and a microcontroller unit incorporated in a Digital Transaction Card.

In some embodiments, the apparatus is in the DTPU. In other embodiments, the apparatus comprises the DTPU and the MCU.

In various embodiments, the DTC includes a user interface including a display (Graphical User Interface (GUI)) and buttons for operating the DTC. The display may be an Electronic Paper Display (EPD). The buttons may include an off/on button, scrolling buttons and a selection button.

In other embodiments, the one or more software packages are applets. The applets may include Java applets in a suitable container in the software layer. It will be understood that, as Java applets, a software package, when operated, becomes an instance of the associated applet in the container. In other embodiments, the software layer may use a MULTOS operating system and the software packages will be adapted to work with that operating system. Scripts can be adapted to work with the various embodiments of software operating systems, such as Java Card and MULTOS.

In some embodiments, a script and an applet are operable to reorder two or more MMPCs stored in the DTPU to cause a selected card to be a primary card operating on the DTPU. In some such embodiments, the applet used for reordering is a PSE/PPSE applet. In embodiments, the user interface of the DTC is operable to display, highlight and select a card to become the primary card operating on the DTPU.

In embodiments, the cards associated with each MMPC are in the hardware (sometimes referred to as firmware or a firmware layer) of the DTC (embedded in the firmware), and the software packages and scripts are in the software (or software layer). The DTC may include a scheme holder (in some example embodiments, implemented as an applet) adapted to store a card (a MMPC) and PAN. It will be appreciated that a “physical” PAN that is installed into a scheme holder would lock the DTC (the DTPU), such that no further MMPCs or cards schemes could be installed.

In embodiments, scripts and applets are operated to disable, deactivate or otherwise cause one or more of two or more MMPCs to be “not seen” by a digital transaction device when operating with the DTC (for example, making a payment with the DTC at an EFTPOS device). In some such embodiments, the applet used for disabling/deactivation or enabling/activation is a PSE/PPSE applet. As such, when using Explicit Selection process, a PSE process, or a PPSE process, the used process will return only the Application ID (AID) associated with a selected MMPC, thus causing the DTC to adopt the personality of the card profile associated with the MMPC for subsequent transactions.

In some embodiments, exhaustion for a script occurs after an activation and/or deactivation, and reordering operation. In other embodiments, exhaustion for a script occurs after an activation and/or deactivation operation alone, or exhaustion of the script occurs after a reordering operation alone. In yet other embodiments, exhaustion of a script may include a larger number of operations of different types than only activation and/or deactivation and reordering operations.

In other embodiments, scripts and applets are operated to deactivate any and all card profiles (may be just one primary card profile) on a DTC. This can be used for disabling a DTC during a detected fraudulent transaction. In such operations, a payment or issuing network entity, for example a TSM, is authorized to enact a disabling operation when a fraudulent transaction is detected or suspected by an acquirer. Similarly, a DTC could be reactivated by the TSM in the circumstance that the DTC has been verified by an acquirer as not being fraudulently used.

In some embodiments, scripts can control the operations of, modify, or instantiate with appropriate parameters the PSE or PPSE to return only a selected card profile during an application selection process. It will be understood that presently cards (including Java Cards) operate with standard PSE/PPSEs. In some such embodiments, a modified PSE/PPSE can be installed, and in further embodiments, the PSE and PPSE are implemented as applets on a Java Card. In an example implementation, the script provides authentication codes to the ISD, which, when confirmed, allows the script to unlock a selected application, for example, an application associated with a Visa credit card (a first scheme) MMPC, and further allows the script to lock other applications (non-selected applications), for example, applications associated with a MasterCard debit card (a second scheme) MMPC, and an Amex credit card (a third scheme) MMPC. The script is then used to update the PSE/PPSE (after appropriate authentication) to only return the Visa credit card (the first scheme) MMPC in an application selection process. In another example implementation, the script updates the PSE/PPSE to allow the PSE/PPSE to lock and unlock the required applications depending upon which has been selected to be the active card.

In embodiments, scripts are stored on and operated by the MCU, and applets in the software layer, along with applications in the hardware (firmware) layer are located on and operated by the DTPU. In other embodiments, the scripts are stored on the MCU and pushed to the DTPU when a script operation is required.

In some embodiments, scripts are configured to operate with MMPCs, as generated, for example, by a TSM. It will be understood that such MMPCs are at least similar to MMPCs a TSM can generate for use on a smartphone in a digital wallet. In other embodiments, scripts are configured to operate with card profiles similar to those provided by an issuer when personalizing a blank card. In this way, scripts can be implemented to work with a range of files representing card personalities to be adopted by a DTC.

In some other embodiments, the DTC can be implemented with a single PIN, which operates for all MVCPs and MMPCs loaded on the DTC.

In various embodiments, an EMV (or more generally a DTPU) may have a Global Platform configuration, with assignable lock privileges. The EMV (DTPU) may also have a preload and storage capacity, capable of functioning as required.

In some embodiments, an example script may have ADPUs for the following functions: SELCT SSD, INITIALIZE UPDATE, EXTERNAL AUTHENTICATE, SET ACTIVE APPLICATION and (optionally) GET DATA—ACTIVATED APPLICATION.

In embodiments, the MMPC can only work in selected Secure elements that: haven't been disabled by blow the fuse; have enough non-ROM memory to support installation of schemes and MMPCs; have Key GP commands activated to enable installation; and have SSD keys issued to allow post installation.

### BRIEF DESCRIPTION OF THE DRAWINGS

At least one embodiment of the invention will be described with reference to the following, non-limiting illustrations representing the at least one embodiment of the present invention, in which:

FIG. 1 is a diagrammatic representation of an example security hierarchy in accordance with an embodiment of the present invention;

FIG. 2 is a diagrammatic representation of an example implementation of scripts on a DTC in accordance with an embodiment of the present invention;

FIG. 3 is sequence diagram showing operations between an MCU and DTPU (EMV) in accordance with an embodiment of the present invention;

FIG. 4 is sequence diagram showing operations between an MCU and DTPU (EMV) in accordance with an embodiment of the present invention;

FIG. 5 is a diagrammatic representation of a communication pathway between a TSM and a DTC for delivering a script to the DTC from the TSM in accordance with an embodiment of the present invention;

FIG. 6 is a diagrammatic representation of a payment and DTC/Modified Mobile Payment Card (MMPC) issuing network in accordance with an embodiment of the present invention;

FIG. 7 is a diagrammatic representation of an example operation for loading MMPCs onto a DTC in accordance with an embodiment of the present invention;

FIG. 7A is a diagrammatic representation of an example operation for loading MMPCs onto a DTC in accordance with an embodiment of the present invention, which differs from that shown in FIG. 7;

FIG. 8 is a diagrammatic representation of an example operation for loading MMPCs onto a DTC in accordance with an embodiment of the present invention different from that shown in FIG. 7;

FIG. 9 is a diagrammatic representation of an example operation of a DTC having its personality changed by a user.

FIG. 10 is a diagrammatic representation of an example implementation of scripts on a DTC in accordance with an embodiment of the present invention;

FIG. 11 is a diagrammatic representation of a method for generating session keys;

FIG. 12 is a diagrammatic representation of an example implementation using a single script on a DTC in accordance with an embodiment of the present invention;

FIG. 13 is a diagrammatic representation of an example security hierarchy in accordance with an embodiment of the present invention;

FIG. 14 is sequence diagram showing operations between an MCU and DTPU (EMV) in accordance with an embodiment of the present invention;

FIG. 15 is a diagrammatic representation of an example security hierarchy in accordance with an embodiment of the present invention;

FIG. 16 is sequence diagram showing operations between an MCU and DTPU (EMV) in accordance with an embodiment of the present invention;

FIG. 17 is a diagrammatic representation of an example security hierarchy in accordance with an embodiment of the present invention;

FIG. 18 is sequence diagram showing operations between an MCU and DTPU (EMV) in accordance with an embodiment of the present invention;

FIG. 19 is a diagrammatic representation of an example security hierarchy in accordance with an embodiment of the present invention;

FIG. 20 is sequence diagram showing operations between an MCU and DTPU (EMV) in accordance with an embodiment of the present invention; and,

FIG. 21 is a sequence diagram showing operations for replenishing scripts on a DTC, in accordance with an embodiment of the present invention.

### DETAILED DESCRIPTION OF SOME EMBODIMENTS

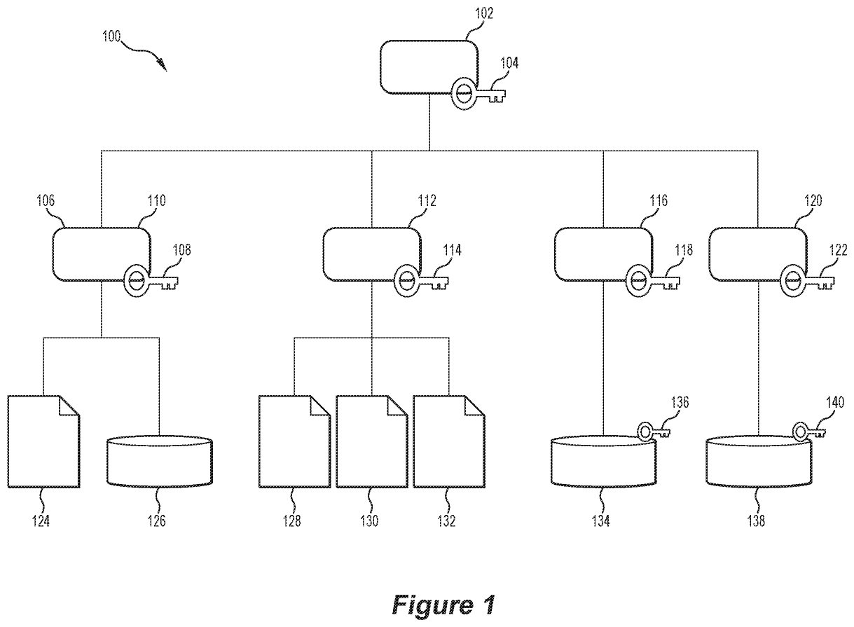

Referring to FIG. 1, an example security hierarchy 100 for a secure element in a DTPU is shown with the top of the hierarchy being the Issuer Security Domain (ISD) 102. The ISD is the owner of the secure element in a DTPU (for example, an EMV chip) on a DTC, and is responsible for content management on the DTC and assigning privileges. The owner of the secure element may be a card issuer, or another authorized third-party managing the secure element as a service. Alternatively, management of the secure element could be the responsibility of a customer (the cardholder), if given the appropriate security authorization and means to operate with that level of responsibility. DTC content management includes functions: LOAD packages, INSTALL applications, and DELETE applications and packages.

The hierarchy uses a Supplementary Security Domain (SSD) 110, which is managed by a third-party for the purposes of changing the personality with which the DTC operates. The third-party personality manager installs an application on the DTC for controlling some operations of the DTC, including operation of the PSE/PPSE and the DTPU (in particular, the secure element of the DTPU). The ability to operate the SSD is provided through the appropriate authorization 108, for example, by provision of keys. The third-party personality manager SSD 110 may also have authority for Global Locking 106.

The third-party personality manager SSD has control of one or more packages 124, which may be implemented as one or more applets. The packages, when called, instantiate one or more corresponding instances 126. In one example, there may be one package for a custom PPSE and another package for a custom PSE, instantiating, respectively, as a custom PPSE instance and a custom PSE instance. With this control under the SSD, the third-party personality manager is able to cause the PPSE and PSE applications to perform operations on the PSE/PPSE of the DTC. In one embodiment, the PPSE gets the Global Lock privilege allowing the LOCKing and UNLOCKing of other applications on the secure element.

According to GPS, the Global Lock privilege provides the right to initiate the locking and unlocking of any Application on the card, independent of its Security Domain association and hierarchy. It also provides the capability to restrict the Card Content Management functionality of OPEN. This allows a single entity on the Secure Element to implement the lock/unlock mechanisms. An off-card entity requiring the lock or unlock functions should be authenticated using the appropriate secure channel.

In one example implementation of a standard command protocol (or a general card and issuing/payment network operation protocol), the Global Platform Standards (GPS), mapping guidelines define which global platform privileges are recommended or optionally supported by the ISD and SSD or applications (for example, applets). In example implementation, each EMV chip can differ, with some EMV chips supporting an extended version of mapping guidelines (called “Mapping Guidelines Plus”). Some implementations of the GPS allow the global lock privilege to be assigned to applications. In embodiments of the present invention, software packages (applications), such as applets, could therefore contain global lock privilege. In other embodiments, global lock privilege could be assigned to a script (or a number of scripts). With such global lock privilege assignment, applets or scripts, when operated, may be enabled to perform LOCK/UNLOCK operations, and other operations requiring a high-level authorization according to the GPS security hierarchy.

The hierarchy 100 also includes an SSD utility 112, with appropriate authority 114 to operate a number of packages relating to various card profiles (VCPs) and their associated payment schemes. In this example embodiment, a first package 128 holds information for a Visa card profile, a second package 130 holds information for a MasterCard profile, and a third package 132 holds information for an Amex profile.

The hierarchy 100 includes two example bank SSDs 116, 120, with associated security 118, 122. The bank SSDs are each associated with a bank hosting applications for the MMPCs 128, 130, and 132. In this example, the first bank SSD 116 is associated with the Visa application, and instantiates a Visa instance 134; the second bank SSD 120 is associated with the MasterCard application and instantiates a MasterCard instance 138. The keysets 136, 140 from these bank SSDs allows personalization of the banking applications. The owners of the bank SSDs 116, 120 are responsible for generating personalization scripts for the banking profile data.

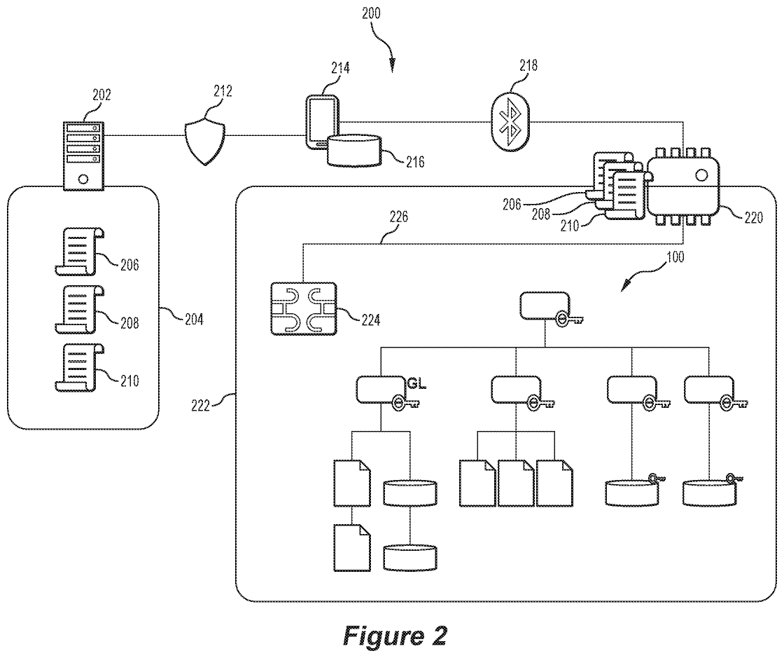

As shown in FIG. 2, the security hierarchy 100 is implemented in the secure element of a DTPU 224 (an EMV chip) on a DTC 222. The DTC also has an external processing chip, a Micro Controller Unit (MCU) 220. The MCU is loaded with scripts 206, 208, and 210, which are generated 204 by a Trusted Service Manager 202 and sent through a Secure Socket Layer (SSL) 212 over the internet to a cardholder's mobile device (smartphone) 214. The smartphone 214 is loaded with an app 216 configured to securely accept the scripts generated by the TSM and to connect with the DTC 222 via Bluetooth 218, and to send the scripts via the Bluetooth link to the MCU 220.

With the scripts 206, 208, and 210 loaded into the MCU the cardholder can perform operations via an interface on the DTC (not shown in FIG. 2). The interface may include buttons operable to allow the cardholder to select a MMPC to become the operating personality of the DTC, and a display showing the cardholder which personality has been selected and is operating. The scripts enable authentication by the MCU of one or more operations for the DTC, including operations in accordance with the security hierarchy 100. As scripts require a valid authentication to be executed by the secure element of the DTPU (EMV), and the information in the script is not confidential, ciphering the data is not required.

In an embodiment, each successful authentication operation disables (exhausts) the script used for that authentication. When a predefined number of scripts have been exhausted, or a predefined number of scripts remain unexhausted, and when the DTC is connected with the smartphone 214, it can notify the smartphone which scripts have been exhausted, and the smartphone (via the app 216) can request a new batch of scripts from the TSM. In this way, the scripts can remain synchronized between those on the DTC and those copies of scripts (or records of the scripts) retained by the TSM.

Another means by which to retain synchronization is to reset the sequence counter after a script has been used for a successful authentication or another operation, which would otherwise exhaust the script. Using GPS, the sequence counter can be reset using a PUT_KEY command, which replaces the existing keyset with an identical keyset having the same key values. This results in the script being valid for further use without immediate replenishment from the TSM. The PUT_KEY command requires authentication to the SSD using the highest security level available, that is, AUTHentication+ENCryption+MAC. There are two types of script for this option: the selection update with security level AUTH, and the update keys script with AUTH+ENC+MAC security level.

Ultimately, when possible, an update from the TSM will still be required to provide a key update with new values. Updating key is a security requirement, and must be done regularly, or the security may be compromised. However, the update can occur as a background task when the DTC is connected with the smartphone.

Although embodiments described in this specification exemplify a smartphone as means to communicate data, including scripts, between a TSM and the DTC, other means may be suitable for this function, including computer tablets, smartwatches (and other wearable mobile communication devices), PCs, laptops and other devices which can be securely connected to a network for secure communication between the device and the TSM, and which can also be connected to the DTC via a suitable communication protocol such as Bluetooth. Further, the TSM and DTC can connect for secure data communication therebetween using digital transaction devices, such as ATMs and POS/EFTPOS terminals when the DTC is used for transactions with those types of device.

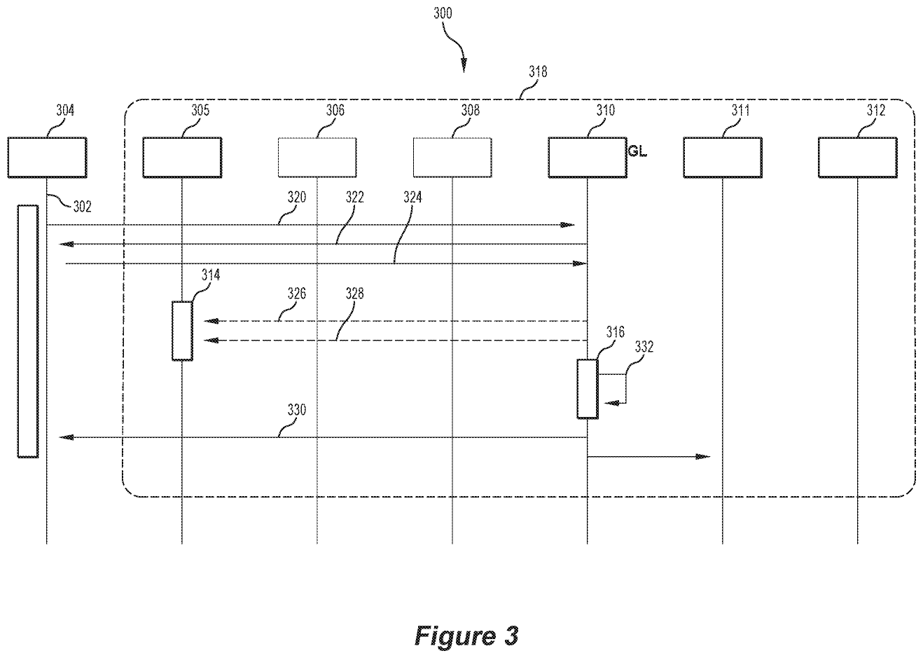

FIG. 3 is a sequence diagram 300 showing an example of how an MCU 304 can operate with scripts to establish a Secure Channel Protocol (in this example, SCP02) 302 for communication with an EMV secure element 318 to effect changes in accordance with the security hierarchy having the highest authority under the ISD 306, such as a change in personality of the EMV by enabling/disabling appropriate applications representing MMPCs on the EMV.

The cardholder uses the DTC interface to select a card (for example, a Visa card) which is to be the new operating personality of the DTC to replace the presently operating personality (for example, an Amex card). The MCU launches the selection process by authentication 320, 322 to the SSD 308 through the PSE/PPSE application 310 using a third-party SSD keys (the third-party being one designated to manage personality changes on the DTC). The MCU then sends a Set Active Application 324 command to the PPSE (for contactless card transactions)—the active application will be the Visa application. The PPSE operates to check the LOCK/UNLOCK state of the applications, LOCKS 326 the application to be deactivated (the Amex card application) using GPS APIs 314, UNLOCKS 328 the application to be activated (the Visa card application), then UPDATES FCI 332 of the PSE/PPSE FCI 316 to accord with the AID of the activated application. The PPSE updates the PSE payment directory. Finally, an OK 330 is sent to the MCU. When next used, the DTC's EMV will have the personality of the Visa card operating and will use the appropriate Visa banking applet 312 in a payment operation.

In the example depicted in FIG. 3, a script used in the operations contains Application Protocol Data Unit (ADPU) commands for authentication using a keyset from a third-party personality management SSD. The script command content may include, for example:
SELECT PPSE;
INITIALIZE UPDATE;
EXTERNAL AUTHENTICATE; and
SET ACTIVE APPLICATION
   commands.

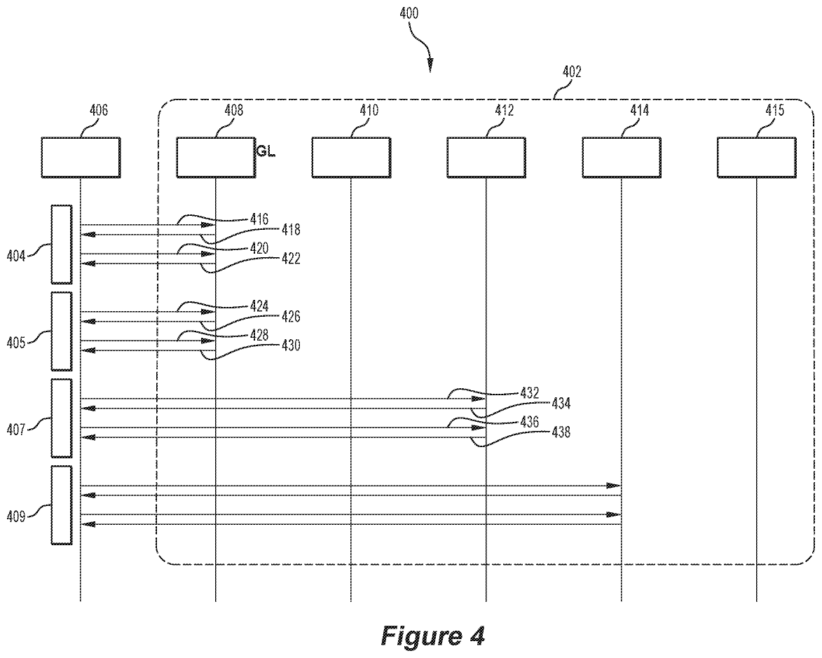

FIG. 4 is a sequence diagram showing another possible implementation of activating/deactivating (unlocking/locking) applications in an EMV secure element 402 on a DTC using scripts for managing authentication in accordance with the security hierarchy (including the ISD 408 and SSD 410). In this example implementation, the ISD 408 has the Global Lock (GL) authority. As with the example depicted in FIG. 3, the cardholder selects a card profile desired for the DTC via the DTC interface (buttons and display). In this example, the cardholder may desire to change the operating personality of the DTC from a MasterCard credit card to the cardholder's bank's debit card. The cardholder's selection causes the MCU 406 to launch a selection process by establishing a secure channel 404 and commences authentication 416 with the ISD 408, and, if successful, receiving an OK message 420 back from the ISD. Other secure channels 405, 407, and 409 are established during the selection process as needed for secure communication between the MCU and EMV. The MCU can then check the LOCK/UNLOCK status of the applications in the DTPU, and select which scripts should be run to effect the change desired by the cardholder. The MCU runs a suitable script with the LOCK command 420 to deactivate the MasterCard credit card, receiving an OK indicator 422 from the ISD 408. The MCU then performs another authentication with the ISD 424, receiving an OK 426, before running another suitable script with the UNLOCK command 428 to activate the cardholder's bank's debit card and receiving an OK indicator 430.

Following the UNLOCKING/LOCKING commands, the MCU selects the next available authentication script and runs this script for authentication 432, 434 before sending a SELECT PPSE command to the PPSE 412 to update 436, 438 the FCI of the PPSE according to the AID of the selected application (the cardholder's bank's debit card application). In a separate action, the MCU can update the PSE 414 payment directory with the activated application's AID. As both the PPSE and PSE are updated, the DTC can be used in contact and contactless transactions with digital transaction devices. The DTC can operate with the appropriate banking applet 415 to effect debit card transactions.

In the example depicted in FIG. 4, three of the script used may include, for example:

Script 1 (LOCK/UNLOCK banking applications):
SELECT SSD;
INITIALIZE UPDATE;
EXTERNAL AUTHENTICATE;
SET STATUS (APPLICATION LOCKED); and
SET STATUS (APPLICATION UNLOCKED).

### Script 2 (UPDATE PPSE FCI):

SELECT PPSE;
INITIALIZE UPDATE;
EXTERNAL AUTHENTICATE; and
UPDATE FCI (FCI CONTENT with AID).

### Script 3 (UPDATE PSE PAYMENT DIRECTORY)

SELECT PSE;
INITIALIZE UPDATE;
EXTERNAL AUTHENTICATE; and
UPDATE FCI PAYMENT DIRECTORY (AID).

Whilst the above examples illustrated in FIGS. 3 and 4 are addressed to changing the operating personality of a DTC, the range of operations which can be performed by using an MCU with appropriate scripts is much broader, and includes actions such as disabling the DTC entirely if a fraudulent or sufficiently suspicious transaction is detected. For example, a DTC may be presented to a digital transaction device, such as an EFTPOS terminal; during the attempted payment transaction, the payment network or the terminal itself detects suspicious activity, for example, multiple entries of an incorrect PIN; the terminal can signal the DTC, which has a script capable of deactivating all MMPCs on the DTPU; and the DTC (MCU on the DTC) runs the script to render the DTC inactive.

Further, in other example embodiments, the DTPU of the DTC could store a wide variety of digital transaction documents, including passports, IDs, age verification documents, loyalty cards, travel cards, along with a range of financial transaction documents, such as credit and debit cards from various payment schemes. In one embodiment, the DTC can be operated via its interface to install any one of the documents as the operating personality of the DTC.

In other embodiments, it is envisaged that, for example, multiple personalities could operate where such personalities have some relationship, such as a credit card and a loyalty card. In such scenarios, the PPSE/PSE may only present the credit card personality for selection by a transaction device, but the DTC could operate an associated loyalty card (a different MVCP on the DTC) to recognise transactions made with the credit card MMPC when it is the active card profile.

In other variations, a single script may be suitable for completing a number of operations for changing a DTC's operating personality. For example, the script may implement a number of authentications and commands required. This would increase the efficiency of each script, thus requiring a smaller number of scripts to be installed on the MCU for executing each personality change operation.

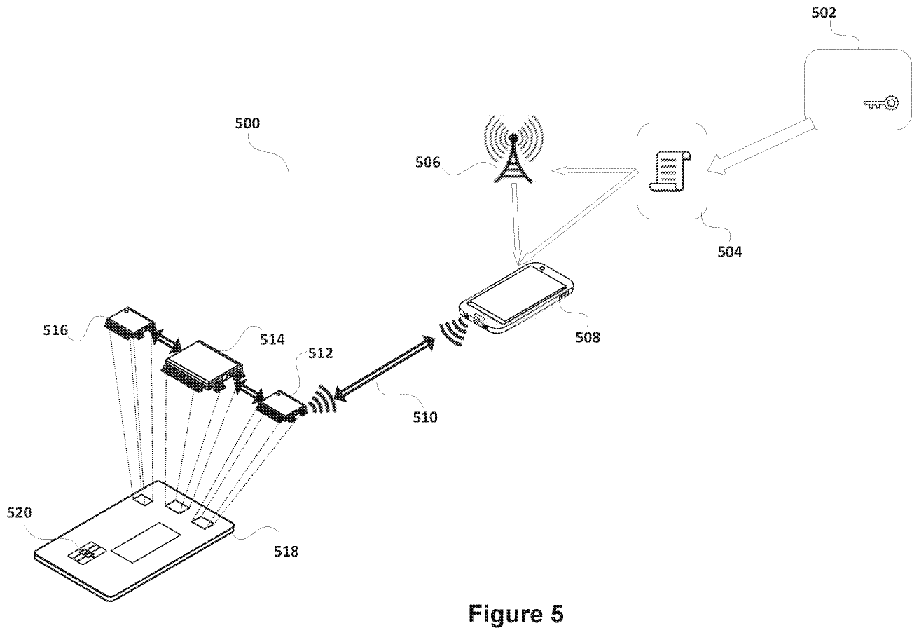

FIG. 5 shows an example embodiment of a communication pathway 500 between a TSM 502 and a DTC 518 for delivering a script 504 from the TSM to the DTC. In one example embodiment, the script is delivered to the MCU 514 on the DTC as an end-point of the communication pathway. In another example embodiment, the script is delivered to the secure memory 516 on the DTC as an end-point of the communication pathway.

The TSM generates the script with a keyset unique to a chosen set of parameters of the DTC. The set of parameters could include, for example, one or more of the following: a DTC unique ID, a MCU unique ID, a key (or keyset) stored in secure memory 516 of the DTC, and a unique ID for the DTPU 520 (in some examples, an EMV chip). The generated script contains commands (ADPU commands) in accordance with, for example, the GPS. As the script is generated with a keyset unique to the chosen parameters, the script cannot be used with other DTCs or other devices (such as mobile payment devices).

The TSM 502 sends the generated script 504 to a mobile device 508 (for example, a DAD or a mobile phone). The TSM can send the script via a secure communication channel, or in the clear. The communication path between the TSM and the mobile device can Over-The-Air (OTA) 506, or by some other pathway.

The mobile device is then able to transfer the script to the DTC 518 via a contactless communication channel 510 to a communication chip 512. Examples of the contactless communication channel are an NFC connection or a Bluetooth™ connection.

Once transferred to the communication chip 512, the script can be passed to the MCU 514 or further transferred to the secure memory 516. When the script has been received by its designated end-point, an acknowledgement of receipt can be sent back through the same or a different communication pathway to confirm to the TSM that the script has been safely received and stored on the correct DTC or other payment device.

In various embodiments, the communication pathway 500, or parts of the communication pathway can be secured to prevent fraudulent activity, such as man-in-the-middle attacks. However, it will be appreciated that a script is generated for a specific device, and cannot be used in other devices, so that a secure communication pathway may not always be required or desired.

It will also be appreciated that the communication pathway 500 could be established as an end-to-end pathway between the TSM 502 and the end-point (for example, the MCU 514, or the secure memory 516). Such a pathway requires maintenance of all connections between points along the pathway for the entirety of the communication process.

In other embodiments, the communication pathway 500 may be comprised of a series of asynchronous communication points. In such embodiments, a script 504 can be delivered from the TSM 502 to a mid-point device, such as the mobile device 508 via a first communication channel part-pathway. The first communication channel part-pathway could then be dropped. The mobile device, being a temporary holder of the script, can then establish a second communication channel part-pathway with the DTC's communication chip 512, which part-pathway has a synchronous connection with the MCU 514, and can also have a synchronous connection with the secure memory 516. The script can be delivered to the end-point, and an acknowledgement can be sent back through a same mix of synchronous and asynchronous communication channel part-pathways.

In embodiments including asynchronous communication channel part-pathways, the entire communication process (including delivery of the script from the TSM to the end-point, and delivery of the acknowledgement back to the TSM) could be time-limited to reduce the risk of fraudulent interception and use of the script. In some examples, the time limit could be 5 minutes, although it will be appreciated that other time limits could be chosen.

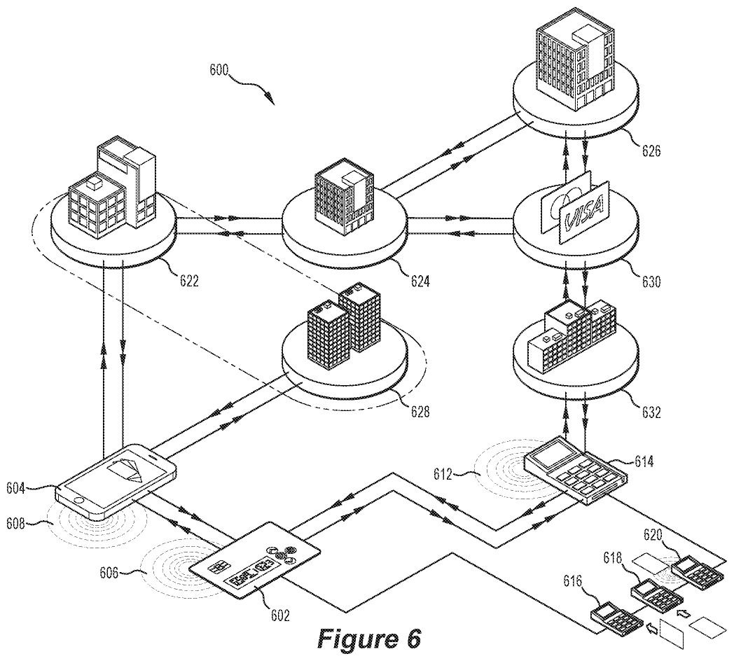

FIG. 6 shows and example environment 600 for issuing a DTC 602, issuing MMPCs to the DTC, issuing scripts for the DTC, along with a payment environment for facilitating digital transactions using the DTC when operating with a personality according to one of the MMPCs which is activated on the DTC. Typical operating dependencies between each of the entities in this environment are indicated by arrowed lines.

The DTC 602 depicted in FIG. 6 is capable of adopting one of a number of available personalities and once a particular personality has been selected and activated, the DTC may be used to perform digital transactions with an existing digital transaction infrastructure including a merchant terminal 614 and may be used to conduct the transaction with existing digital transaction infrastructure according to the available modes of use of a DTC with a merchant terminal including use of NFC/contactless capabilities 612 for contactless payment 620, physical contact with the EMV contacts 618 or a magnetic stripe on the rear of the DTC 616.

Further, in FIG. 6, an arrangement is depicted wherein the personality adopted by the DTC 602 relates to the selected MMPC of a credit card and transactions effected by using the DTC with the adopted personality use tokens to improve the security of the credit card transaction.

In this regard, in the embodiment detailed in FIG. 6, an issuer 626 initially issues the credit or debit card and creates an account for the account holder. The account is identified by a Primary Account Number (PAN) that identifies the issuer and the particular card holder account. Alternatively, the issuer may issue a blank card for subsequent installation of all personalities (represented by MMPCs) required by the user. Further, the issuer could also issue a card with a single MMPC installed that is supplied by a TSM 622.

When a consumer uses their DTC 602 in a credit card transaction with a merchant terminal 614, the merchant terminal interacts with an acquirer 632 and passes payment data and the token to the acquirer for authorisation of the transaction.

The acquirer 632 is an entity that processes credit or debit card payments on behalf of a merchant. The merchant acquires a credit card payment from the card issuer 626 within a payment scheme 630. The acquirer exchanges funds with an issuer on behalf of the merchant. With respect to the process associated with the transaction, the acquirer passes the payment data and token received from the merchant to the payment scheme. The payment scheme then requests that a token service provider 624 convert the token collected by the merchant and received from the acquirer back to the associated PAN. The token service provider provides the original PAN to the payment scheme and the payment scheme passes the PAN to the issuer and receives an account number for the payment. The issuer verifies the availability of funds and either authorises or declines the payment and communicates the authorisation or otherwise to the payment scheme. In turn, the payment scheme provides authorisation, or declines to provide authorisation, to the acquirer and the authorisation is provided from the acquirer to the merchant terminal 614. If payment is authorised, the merchant provides the goods and/or services to the user of the DTC and the merchant is assured that it, he or she will receive funds in return for the goods and/or services provided.

Optionally, at the time the issuer 626 issues a credit or debit card and creates an account for the account holder, the issuer provides a request to a TSP 624 to generate tokens for the PAN that identifies the issuer and the particular account holder. In the instance of FIG. 5, since the DTC 602 is operable to adopt one of many different personalities, it can behave in a similar manner to a digital wallet without the constraints that are normally encountered when operating a digital wallet.

FIG. 6 also details a Trusted Service Manager (TSM) 622 which receives tokens from the token service provider 624 for the purpose of creating a MMPC. The TSM securely distributes MMPC data (sometimes referred to as virtual card data) to an account holder's mobile device 604. The role of the TSM is to ensure that MMPC data is securely packaged and transferred to the secure element of a mobile device. The mobile payment data may be secured by keys. In the example of FIG. 5, the TSM generates a MMPC in the form of a CAP file for installation into the mobile device 604 and for transfer onto the DTC 602. CAP files containing MMPC data are transmitted wirelessly to the secure element of a user's mobile device. The TSM is also responsible, in this embodiment, for issuing scripts which allow the DTC to perform operations requiring authorization in accordance with the security hierarchy, including the operations required for changing the operating personality adopted by the DTC 602.

The user's mobile device 604 may be identified by various pieces of information regarding the device, that when considered in combination, form a “mobile device fingerprint.” The mobile device executes a digital wallet application and communicates 608 with the DTC 602 preferably by use of a wireless communication protocol such as NFC or Bluetooth 606.

The user may download a wallet application from a wallet service provider 628 for installation on their mobile device 604 wherein the wallet service provider digital wallet application allows the user to carry multiple credit cards in a MPC format or other information in a digital format suitable for a mobile device on their mobile device. In the instance of FIG. 6, the digital wallet application also includes a module that provides the functionality for the digital wallet application to communicate and interact with the DTC 602. Once the digital wallet application has been downloaded from the wallet service provider to the mobile device, the TSM can identify the mobile device by the “mobile device fingerprint” and can download MMPCs (sometimes in the form of CAP files) for installation into the digital wallet application and hence, becomes available for transfer onto the DTC for use in an existing digital transaction network according to the personality encapsulated within the MMPC file.

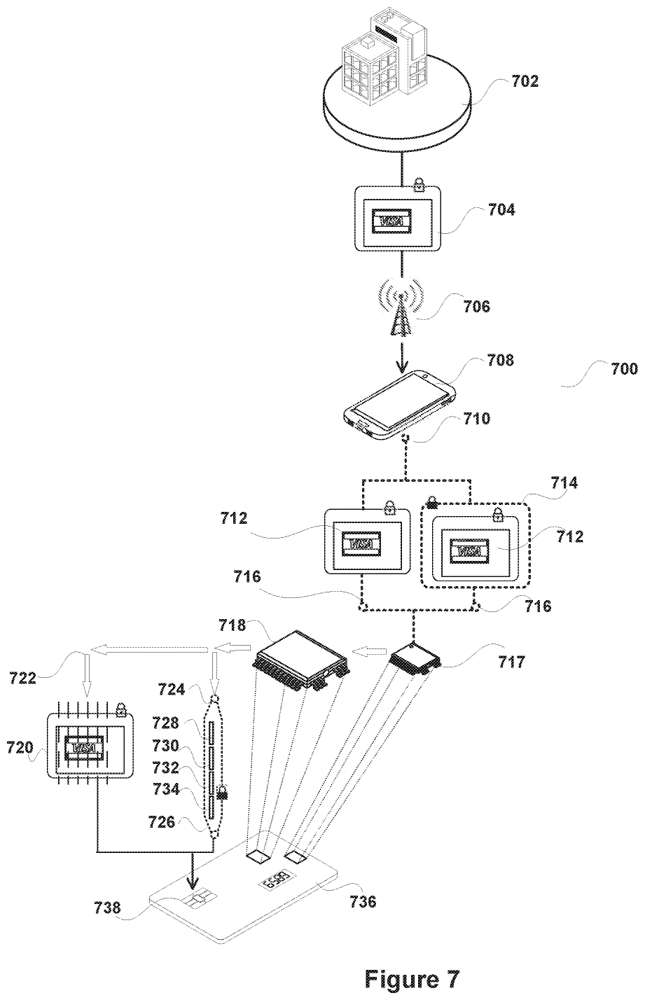

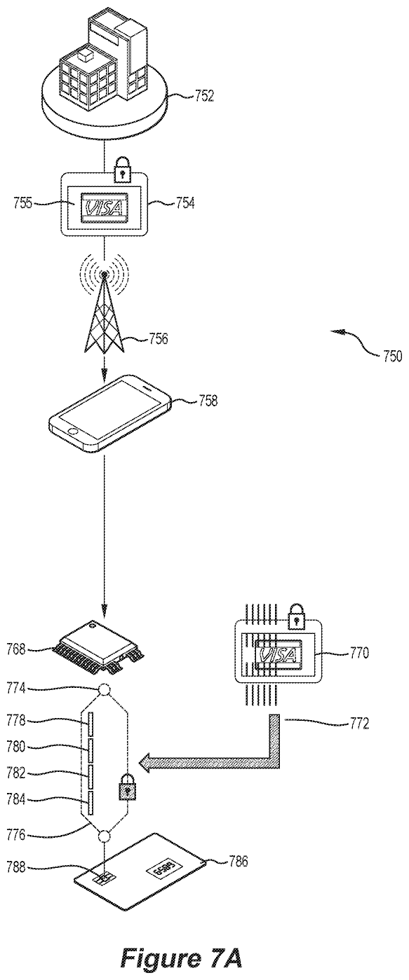

FIG. 7 shows one possible arrangement 700 for providing a MMPC 704 to a DTC 736, in this example, via a mobile device such as a smartphone 708. A TSM 702 generates a MMPC in cooperation with other card profile issuing entities, such as issuers (which may also be referred to as banks), and transmits the profile securely over the air 706 to a cardholder's smartphone 708. An encrypted profile with EMV ISD keys held within the TSM is linked/matched with EMV ISD keys held within the EMV (738). The MMPC is transmitted via a SSL link or similar. The smartphone optionally establishes an end-to-end secure communication link 710, 716 with a communication chip 717 (for example, using NFC or BluetoothlM). The communication chip 717 establishes an end-to-end secure communication link with an MCU 718 on the DTC 736 for secure transfer of an encrypted file 712 (same as 704) relating to the MMPC. The file is encrypted using key pairs or SCP 714 in accordance with the security hierarchy.

The MCU transfers the MMPC to the DTC's DPTU 738, an EMV chip in this example, by splitting the MMPC into ADPUs 720 and transferring 722 each of the ADPUs to the EMV optionally via a secure session 724. In this example, the secure session comprises 4 ADPUs 728, 730, 732, and 734, each transmitted through the tunnel to the EMV.

FIG. 7A shows an alternative arrangement 750 to that shown in FIG. 7, for providing a MMPC 754 to a DTC 786, in this example, via a mobile device such as a smartphone 758. A TSM 752 generates a MMPC in cooperation with other card profile issuing entities, such as banks, and transmits the profile securely over the air 756 to a cardholder's smartphone 758. The smartphone communicates with an MCU 768 on the DTC 786 for secure transfer of the file 754 (in this example, for a Visa card 755) relating to the MMPC.

The MCU transfers the MMPC to the DTC's DPTU 788, an EMV chip in this example, by splitting the MMPC into ADPUs 770 and transferring 772 each of the ADPUs to the EMV optionally via a secure session 774. In this example, the secure session comprises 4 packets 778, 780, 782, and 784, each transmitted through the tunnel to the EMV.

The communication between the smartphone and the MCU without further encryption (in the clear) is possible because the MMPC is sent from the TSM to the smartphone as an encrypted file. Further, though the file contains information to verify that the MMPC is being installed on the correct DTC, the information is encrypted with keys between the TSM and the EMV chip with checks and balances including device fingerprints and challenge responses to ensure encrypted information is forwarded only to the correct EMV chip. The codified information is associated with the actual data, such as PAN, cardholder's name, etc, in another location. As such, even if the MMPC file is intercepted and decrypted, the information contained therein is not immediately useful for identifying the DTC, the cardholder or other critical information.

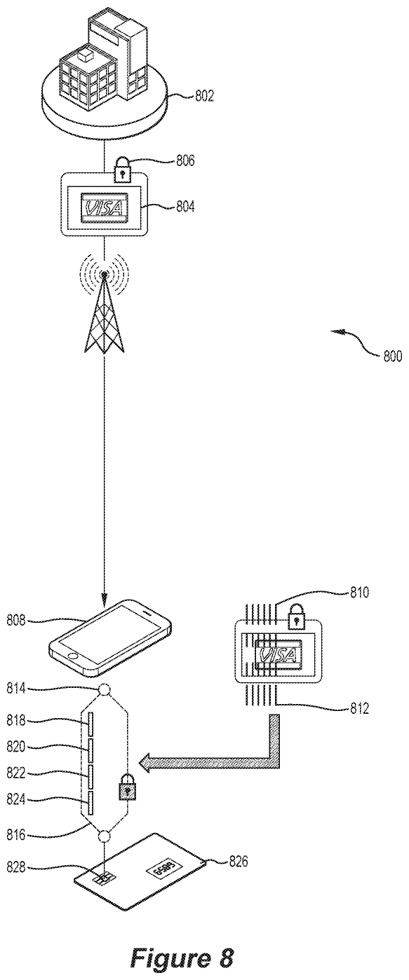

FIG. 8 shows an alternative arrangement 800 to that depicted in FIG. 7 where the MMPC 804 is transmitted from the TSM 802 as an end-to-end encrypted (via SCP) MMPC file 806 to the cardholder's mobile device 808 and is transferred directly to the DTPU 828 of the cardholder's DTC 826, rather than being transferred through an MCU as depicted in FIG. 7. Similar to the process shown in FIG. 7, the encrypted MMPC file 810 stored on the mobile device is split into ADPUs 812 and transmitted, optionally via a secure session 814, with a tunnel 816, the transmission comprising 4 packets 818, 820, 822, and 824, each transmitted through the tunnel to the EMV. It will be appreciated that, in this embodiment, the MMPC file is already encrypted with end-to-end by using SCP, optionally the MMPC file can be double encrypted with a secure session between phone and EMV chip.

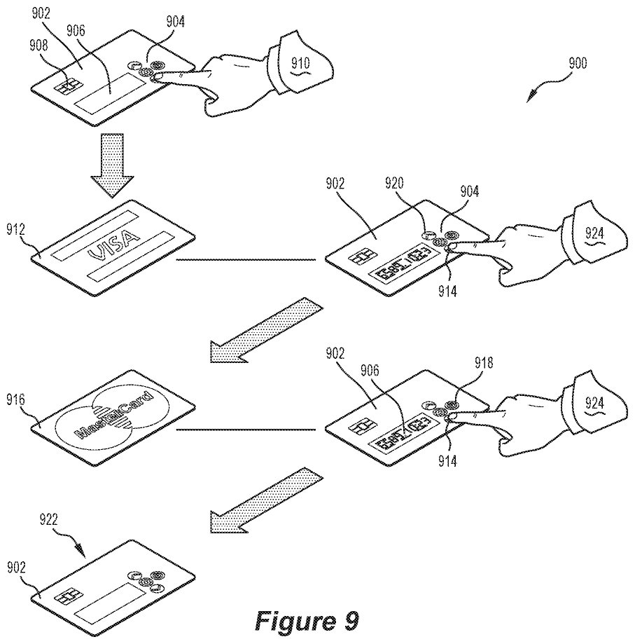

FIG. 9 shows and example scenario 900 where a cardholder 910 changes the operating personality of a DTC 902 using the DTC's interface including card buttons 904 and a display 906. In the example, the DTC starts with a NULL personality, in which case the DTC will not be able to perform any transactions. The cardholder selects a personality desired for a next digital transaction, in this example, a Visa credit card personality 912. After using the DTC for one or more payment transactions, the cardholder may wish to change 924 the DTC's operating personality to that of a MasterCard credit card 916, so the cardholder presses the up and down scroll buttons 920, 914 until the display shows the MasterCard personality, the cardholder then presses a select button to cause the DTC to activate that personality. For security, the DTC can be reverted to a NULL personality 922 until the cardholder wishes to use the DTC for another payment.

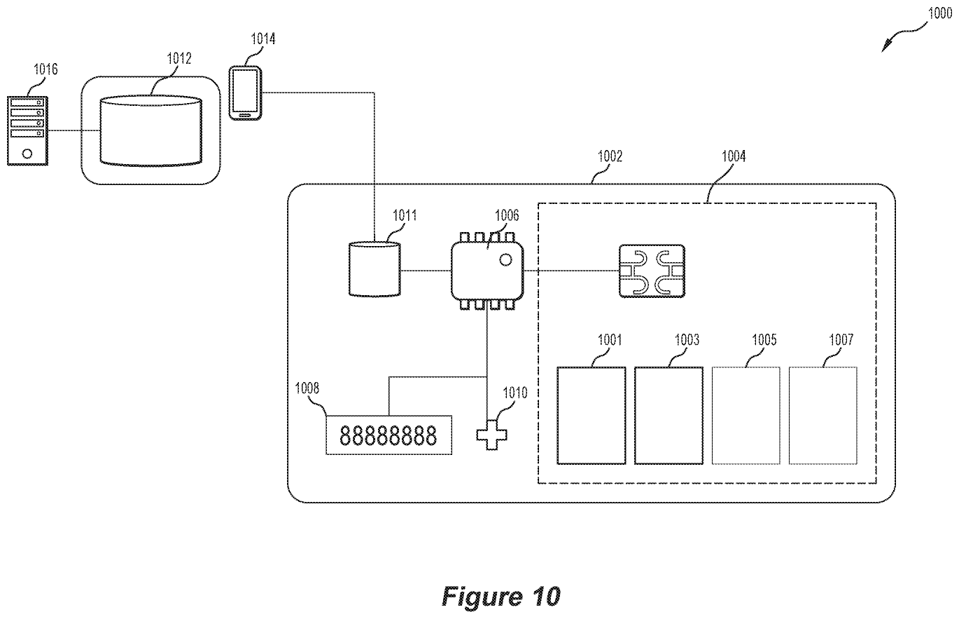

FIG. 10 shows another embodiment 1000 of a DTC in accordance with and embodiment of the present invention. The DTC 1002 (sometimes referred to as a “Companion Card”) includes an EMV chip (DTPU) 1004, the MCU 1006 and a digital screen 1008 with touch controls 1010 to select the payment application (the personality of the DTC presented to a digital transaction device as represented by a MMPCloaded on the DTC). The DTC also has a wireless interface (for example, Bluetooth™ or NFC) 1011 for communication with a user's mobile device 1014. The EMV operates with a PPSE applet 1001, a PSE applet 1003, and has various payment applications installed 1005 . . . 1007.

The DTC operated mobile application 1012 on the user's mobile device 1014 provides management features of the DTC for the user. The library included in the mobile application may include the following features:
An HTTPS Administration Agent to receive a connection from a TSM and forward APDUs to the DTC;
APIs for triggering the DTC remote management from the TSM; and,
Bluetooth interface with the DTC using MCU capabilities.

A Trusted Service Manager (TSM) 1016 may be responsible for:
Hosting the Card Content Management Keys (according to Global Platform definition); and,
Managing the DTC lifecycle.

The MCU is a controller with the following functions:
Control the embedded screen;
Provide a Bluetooth connection with the mobile phone; and,
Be able to transfer APDUs from the phone to the EMV chip.

The EMV chips hosts one or more payment application and a customized PSE/PPSE application. The EMV relies GPS for application management.

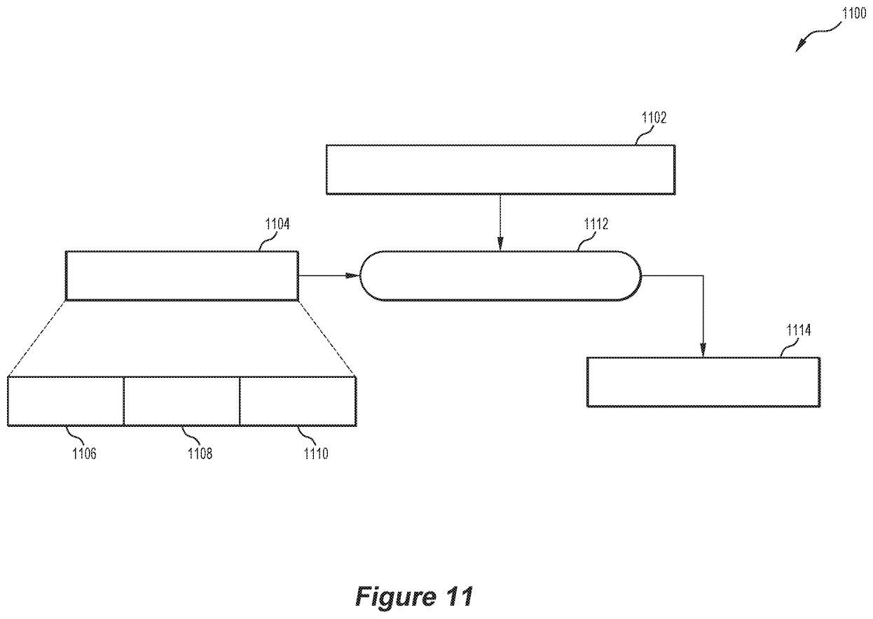

As shown in FIG. 11 in a diagrammatic representation 1100, the MCU must authenticate to the Receiving Entity with the appropriate set of GPS keys. In one example circumstance, the authentication required by SCP02 is mutual and requires the exchange of challenges between the host and the card. In another example circumstance, using SCP02i55 allows using a Pseudo Random Value as a card Challenge.

In FIG. 11, there is depicted elements of generating a session key 1114, including the Secure Channel base key (16 bytes) 1102, and the derivation data (16 bytes) 1104 (made up from a Constant (2 bytes) 1106, a Sequence Counter (2 bytes) 1108, and ‘00’ Padding (12 bytes) 1110), the Secure Channel base key and the Derivation data are fed into a CBC encryption process 1112 to produce the Session Key (16 bytes) 1114.

The pseudo Random is calculated as follows:
The AID of the application requesting opening of a secure channel is padded (in the example shown in FIG. 11, the receiving entity application AID);
A MAC is calculated across the padded data—Single DES Plus Final Triple DES MAC, using the C-MAC session key and an ICV of binary zeroes; and
The six leftmost bytes of the resultant MAC constitute the card challenge.

The MCU and the Secure Element can generate the same well-known pseudo random number if they have the following information:
The SSD base keys;
The AID of the application (on a Java Card, this will be an applet) requesting to open the SCP; and,
The sequence counter used in session keys calculation.

The MCU stores scripts that are generated by the TSM using SCP02i55:
Keys are securely hosted by the TSM;
The script contains APDUs for authentication; and,
Commands required for LOCK mechanisms.

The last step describes the resultant action: activating one application at a time. To do so, the receiving entity:
LOCKS previously activated application
UNLOCKS the application to activate, using GPS SSD APIs.

Furthermore, the FCI of the PPSE and the PSE applications are updated with activated application AID. To apply such a resultant action, the receiving entity registers all the applications which should have their state modified.

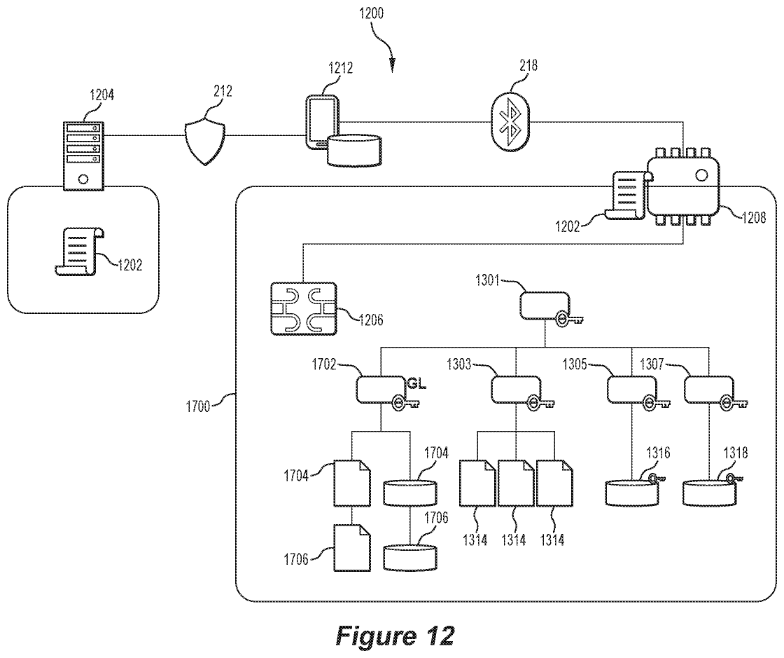

FIG. 12 shows another example embodiment 1200 of the invention using a single script 1202 which can be refreshed by resetting its sequence counter (an alternative to loading a DTC with a number of scripts, each exhausted after performing a given action).

Similar to the example shown in FIG. 2, a script 1202 is stored on the MCU 1208 and is downloaded from the TSM 1204 after the DTC 1210 initiation. To avoid losing synchronization, the sequence counter is reset at the end of each script use by means of a PUT KEY command (a GPS command). The PUT KEY command replaces the existing keyset a with an identical keyset with the same key values, and the script in the MCU remains valid for further use without any update from the TSM. An Update from the TSM will be required on a key update with new values. Updating the key is required on regular basis, as security is compromised the longer a script is not updated. This can be done as a transparent task when the DTC is connected to the user's phone 1212 or another capable device, such as a digital transaction device (ATMs, POS/EFTPOS terminals, etc.).

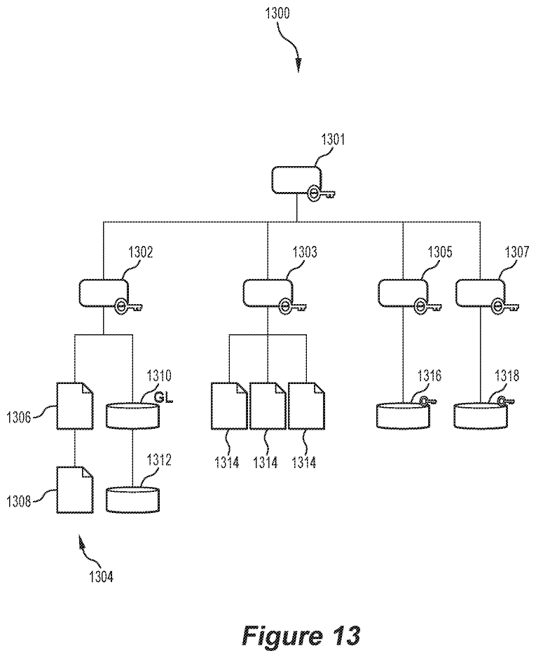

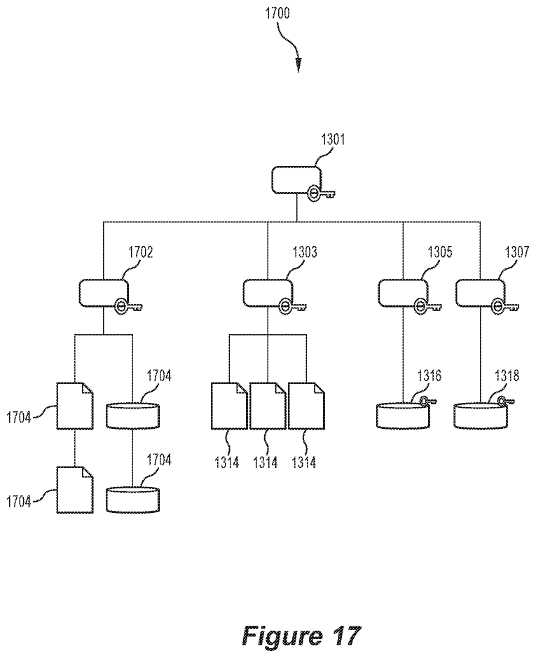

Also shown in FIG. 12 is a security hierarchy 1700 (refer to FIGS. 13 and 17 for details of the nodes in the hierarchy), in which the custom SSD 1702 has the Global Lock (GL) privilege.

In another example embodiment, Global Lock privileges (from GPS standards) are assigned to the PPSE as shown in FIG. 13, which shows a security hierarchy 1300 for such embodiment. The hierarchy introduces a SSD 1302, dedicated to customizing payment environment applications 1304. The following applies for this implementation:
The PPSE is the receiving entity;
SCP02 scripts target the PPSE with AUTHENTICATED security level;
The PPSE manages the selection process;
The MCU builds the scripts using the SET ACTIVATED APPLICATION command; and
PSE is updated by PPSE.

Further implications of the embodiment shown in FIG. 13 include the custom PPSE/PSE applications being stored under this SSD responsibility; the PPSE gets a Global Lock privilege that allows LOCKing/UNLOCKing of other applications on the secure element; and, the keyset for this SSD is used only for LOCKing/UNLOCKing.

In FIG. 13, the custom PPSE is installed under the SSD 1302 as a PPSE package 1306, which is instantiated 1310 with Global Lock privileges. A PSE package 1308 is also installed, and can be instantiated 1312, but without Global Lock privileges.

Under a different SSD for utilities 1303, there are installed payment packages for various schemes (for example, Visa, MasterCard, Amex) 1314. The payment packages are instantiated under various SSDs associated with a financial institution, for example, a bank. In FIG. 13, a Visa payment package 1316 is instantiated under a first SSD 1305 for a first bank, and a MasterCard payment package 1318 is instantiated under a second SSD 1307 for a second bank.

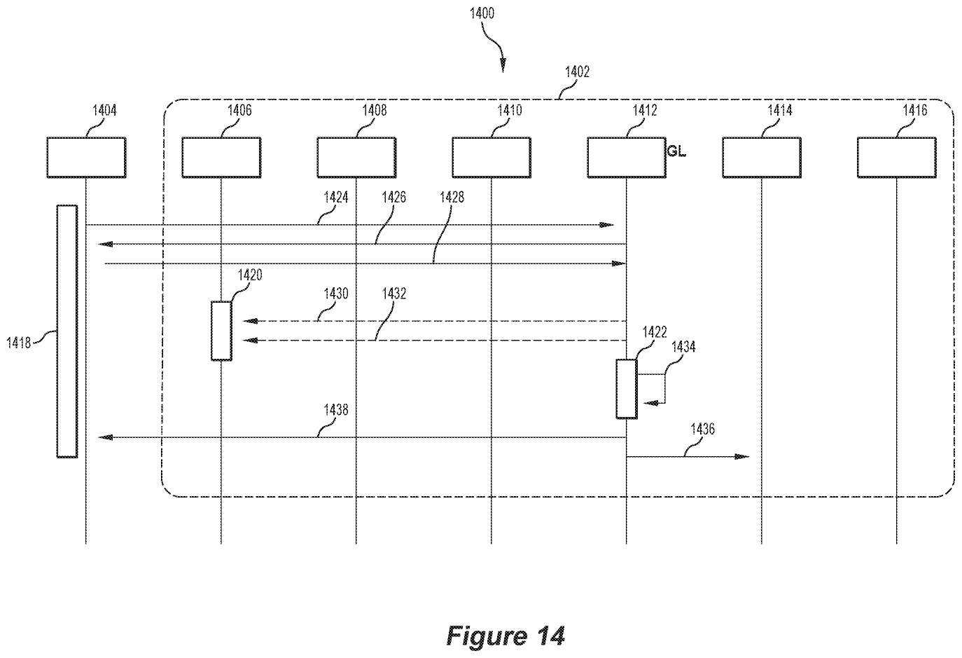

The sequence diagram 1400 shown in FIG. 14 indicates an example process using the security hierarchy of FIG. 13, and includes the following steps:
Step 1: The user operates the embedded screen to select the new active application (App 3);
Step 2: MCU 1404 launches the selection process (in operation with the EMV 1402) by: authenticating 1424/1426 to the SSD through the PSE/PPSE application using custom SSD keys 1302 (see FIG. 13), and sending the Set Active Application command 1428 to the PPSE 1412;
Step 3: the PPSE runs the selection business rule to check the state (LOCK/UNLOCK) 1430/1432 of applications, LOCKs 1430 the deactivated application using GPS APIs 1420, UNLOCKs the application to be activated, and UPDATEs 1434 the FCI 1422 according to the activated application AID; and,
Step 4: the PPSE updates 1436 the PSE 1414 payment directory.

In FIG. 14, the PPSE 1412 has GP Global LOCK privilege. Also shown in FIG. 14 are the ISD 1408, the SSD 1410, and a banking applet 1416. The process shown in FIG. 14 uses a secure channel 1418 for communication between the MCU and the EMV.

In the embodiment shown in FIG. 14, the PPSE 1412 and the PSE 1414 share the same list of AIDs. The sequence counter is shared between all scripts, which implies that each time a script execution is successful, the scripts of other applications that have been generated with the same counter are disabled. Further, each time a selection is performed, one script per banking application installed is disabled.

In the example shown in FIGS. 13 and 14, the MCU is responsible for:
keeping track of the banking application AIDs;
creating the SET ACTIVE APPLICATION command with the target application AID;
appending the SET ACTIVE APPLICATION command to the authentication script; and,
pushing the script to the secure element.

The script contains the APDU commands for Authentication using the SSD 1302 keyset. The secure channel used is SCP02i55. The security level is set to AUTHENTICATED to allow the MCU to add the SET ACTIVE APPLICATION command at the end of the script.

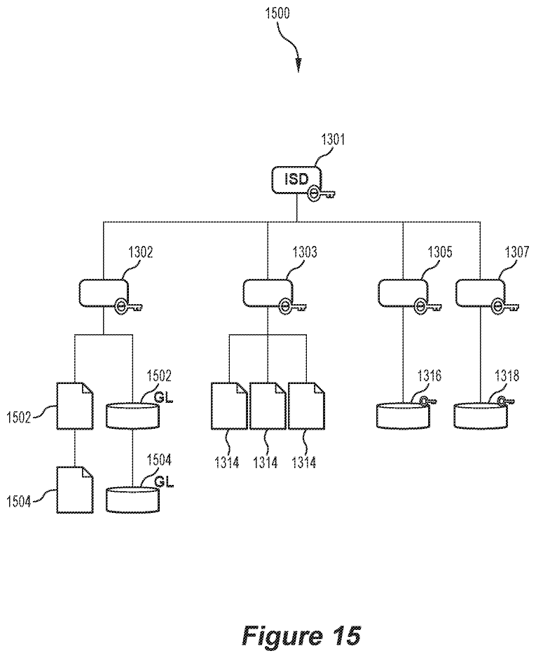

The PPSE implements the business rule for selection processes for all banking applications, both for contact and contactless transactions. FIG. 15 shows an embodiment of a security hierarchy 1500 where the Global Lock privilege is assigned to the PPSE 1502 and the PSE 1504 with the following consequences:
There are 2 receiving entities: the PPSE and the PSE;
SCP02 scripts target the PPSE and the PSE with AUTHENTICATED security level;
The selection process of contact and contactless payment applications are separated;
The MCU builds the scripts using the SET ACTIVATED APPLICATION command; and,
The MCU sends a script to the PPSE and to the PSE for each selection.

Further, Both the PSE and the PPSE have Global Lock privilege, and they both require authentication to use the lock features.

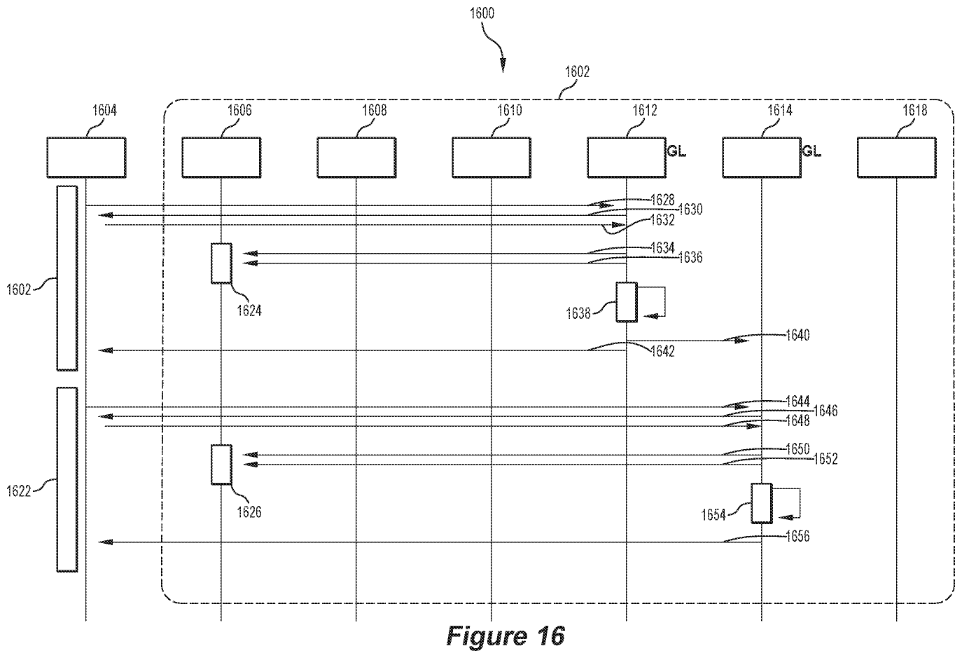

FIG. 16 shows a sequence diagram 1600 which exemplifies a process using the security hierarchy (with the ISD 1608, being atop the hierarchy) shown in FIG. 14, which is implemented in the EMV (DTPU) 1602. The process includes the following steps:
Step 1: The user operates the embedded screen to select the new active application;
Step 2: the MCU 1604 launches the selection process by authenticating 1628 to the SSD 1610 through the PPSE 1612 application using custom SSD keys, and sending the SET ACTIVATED APPLICATION GPS 1630, 1632 command to the PPSE (in this implementation, the PPSE has the Global Lock (GL) privilege);
Step 3: the PPSE runs the selection business rule for contactless cards checking the state (LOCK/UNLOCK) of applications, LOCKing 1634 the deactivated application using GPS API 1624 (which have the state of being OPEN 1606), UNLOCKing 1636 the application to be activated, and UPDATEing the FCI 1638 according to the activated application AID;
Step 4: the PSE 1614 runs the selection business rule for contact cards checking the state (LOCK/UNLOCK) of applications 1644, 1646, 1648, LOCKing 1650 the deactivated application using GPS API 1626, UNLOCKing 1652 the application to be activated, and UPDATEing the payment directory 1654 according to the activated application AID.

The impact on the MCU for the process shown in FIG. 16 is similar to that shown in FIG. 14. However, the number of required scripts is doubled to account for actions performed with the PPSE and the PSE. The scripts contain the APDU commands for authentication using the custom SSD keyset. The secure channel used is SCP02i55 1620, 1622. Both the PPSE and the PSE support authentication. The security level is set to AUTHENTICATED to allow the MCU to add the SET ACTIVE APPLICATION command at the end of the script. The PPSE implements the business rule for selection process for contactless banking applications. The PSE implements the business rule for selection process for contact applications.

Throughout the process shown in FIG. 16, a number of confirmation steps are implemented, whereby “OK” messages 1630, 1642, 1646, 1656 are sent by various actors to confirm a step in the process has been completed successfully. It will also be seen that the PPSE can communicate 1640 with the PSE for updating. Also shown in FIG. 16 is a Banking Applet 1618.

In an example embodiment, as shown in FIG. 17 depicting an example security hierarchy 1700, the Global Lock privilege may be assigned to a custom SSD 1702 with the following implications:
The receiving entity is the custom SSD;
SCP02 scripts target the custom SSD with the AUTHENTICATED security level;
The custom SSD receives only standard commands;
The MCU implements the business logic and generates LOCK/UNLOCK commands; and,
The PPSE and the PSE implement custom commands, respectively, to update their FCI and payment directory.

In the example embodiment shown in FIG. 17, the PPSE 1704 and the PSE 1706 do not have Global Lock (GL) privilege.

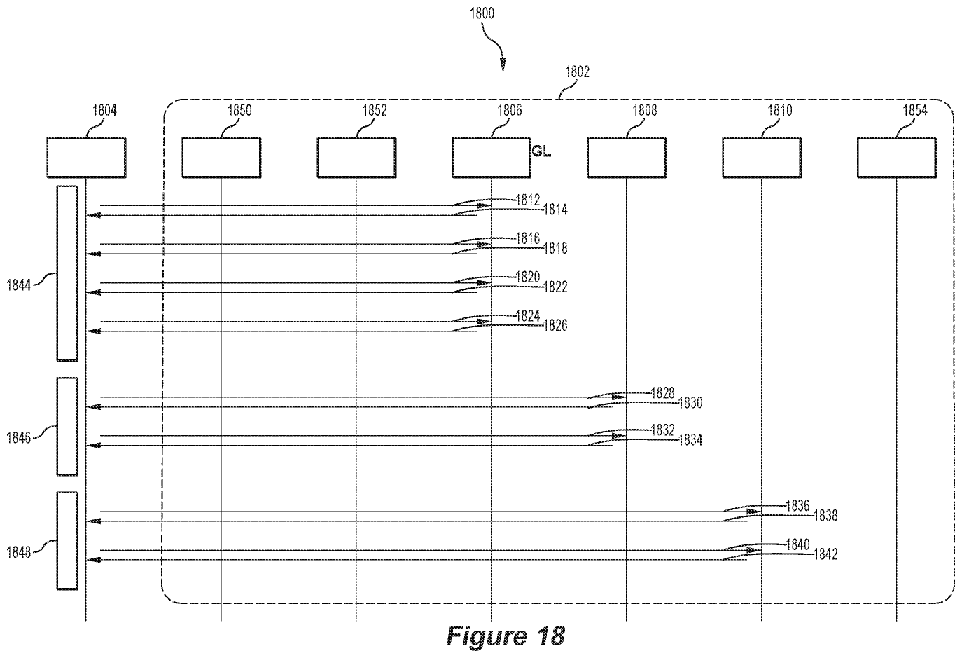

FIG. 18 shows a sequence diagram 1800 which exemplifies a process using the security hierarchy shown in FIG. 17, implemented on the EMV (DTPU) 1802, including an ISD 1852 and an SSD 1806 (the SSD having Global Lock (GL) privilege). The process includes the following steps:
Step 1: The user operates the embedded screen to select the new active application
Step 2: the MCU 1804 runs the selection business rule to check 1812 the state (LOCK/UNLOCK) of applications, select the next available authentication script, append the LOCK command 1820, 1824 to deactivate the presently active application, and, to append the UNLOCK command 1816 to activate the application selected by the user;
Step 3: the MCU updates PPSE 1808 FCI, selects the next available authentication script 1828, and sends a SELECT PPSE command, and UPDATES FCI 1832 according to activated application AID;
Step 4: the MCU updates PSE 1810 payment directory, selects the next available authentication script 1836, and sends a SELECT PSE command, and UPDATES the payment directory 1840 according to activated application AID.

In the embodiment depicted in FIGS. 17 and 18, the MCU implements the business rules, which implies having an up-to-date registry of the activated/deactivated applications. It also implies having the MCU building scripts for both LOCK/UNLOCK mechanisms and the PPSE and the PSE update. However, if the MCU is not a secured device, having such responsibilities may require additional security checks.

Throughout the process shown in FIG. 18, a number of confirmation steps are implemented, whereby “OK” messages 1814, 1818, 1822, 1826, 1830, 1834, 1838, and 1842 are sent by various actors to confirm a step in the process has been completed successfully. Also shown in FIG. 18 is a Banking Applet 1854, and the OPEN state 1850.

The script stored contains the APDU commands for authentication using the custom SSD keyset. The secure channel 1844, 1846, 1848 used is SCP02i55. The security level is set to AUTHENTICATED to allow the MCU to add appropriate set of commands. As the AID of the targeted application enters in the computation of SCP02, 4 different types of scripts are maintained:
For LOCKing
For UNLOCKing;
For UPDATING the PPSE FCI; and
For UPDATING the PSE payment directory.

All 4 scripts may be sent in the same sequence:
1st Script content: (LOCK/deselected banking app):
   SELECT SSD
   INITIALIZE UPDATE
   EXTERNAL AUTHENTICATE
   SET STATUS (APPLICATION LOCKED);
2nd Script content: (UNLOCK/Selected banking app):
   SELECT SSD
   INITIALIZE UPDATE
   EXTERNAL AUTHENTICATE
   SET STATUS (APPLICATION UNLOCKED);
3rd Script content: (UPDATE PPSE FCI):
   SELECT PPSE
   INITIALIZE UPDATE
   EXTERNAL AUTHENTICATE
   UPDATE FCI (FCI CONTENT with AID);
4th Script content: (UPDATE PSE PAYMENT DIRECTORY):
   SELECT PSE
   INITIALIZE UPDATE
   EXTERNAL AUTHENTICATE
   UPDATE PAYMENT DIRECTORY (AID).

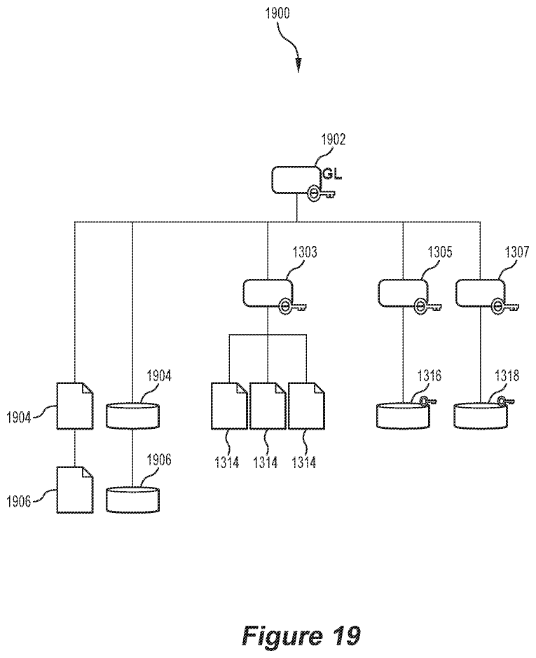

FIG. 19 shows an embodiment of a security hierarchy 1900 where the Global Lock privilege is assigned to the ISD 1902, with the following implications:
The receiving entity is the ISD 1902;
SCP02 scripts target the ISD with AUTHENTICATED+MAC+ENCRYPTED security level: this is the ISD minimum security level;
A specific keyset is created for selection process;
The ISD receives only standard commands;
The MCU implements the business logic;
Commands cannot be appended by the MCU without cryptographic computations; and,
The PPSE 1904 and the PSE 1906 implement custom commands, respectively, to update their FCI and payment directory.

Example of script to use for 4 selections:

| | | | | Script 3 | Script 4 |
|---|---|---|---|---|---|
| | Counter | Script 1 | Script 2 | (UPDATE | (UPDATE |
| | Value | (LOCK) | (UNLOCK) | PPSE) | PSE) |
| 1st | 1 | ✓ | ✓ | ✓ | ✓ |
| selection | | | | | |
| 2^{nd} | 2 | ✓ | ✓ | ✓ | ✓ |
| selection | | | | | |
| 3^{rd} | 3 | ✓ | ✓ | ✓ | ✓ |
| selection | | | | | |
| 4^{th} | 4 | ✓ | ✓ | ✓ | ✓ |
| selection | | | | | |

Every script is used.

In another example, it is possible for the scripts to share the same keyset. In such circumstances, the sequence counter is shared by all the scripts, so each script needs to have a sequence counter increased by 1.

| | | | | Script 3 | Script 4 |
|---|---|---|---|---|---|
| | Counter | Script 1 | Script 2 | (UPDATE | (UPDATE |
| | Value | (LOCK) | (UNLOCK) | PPSE) | PSE) |
| 1st | 1 | ✓ | X | X | X |
| selection | 2 | X | ✓ | X | X |
| | 3 | X | X | ✓ | X |
| | 4 | X | X | X | ✓ |
| 2nd | 5 | ✓ | X | X | X |
| selection | 6 | X | ✓ | X | X |
| | 7 | X | X | ✓ | X |
| | 8 | X | X | X | ✓ |

Scripts marked with a X are discarded (or not generated by the TSM) because the sequence counter is not applicable.

Performing one selection consumes 8 scripts (4 LOCKs and 4 UNLOCKs) per banking application and 8 scripts per selection app (4 PPSE and 4 PSE).

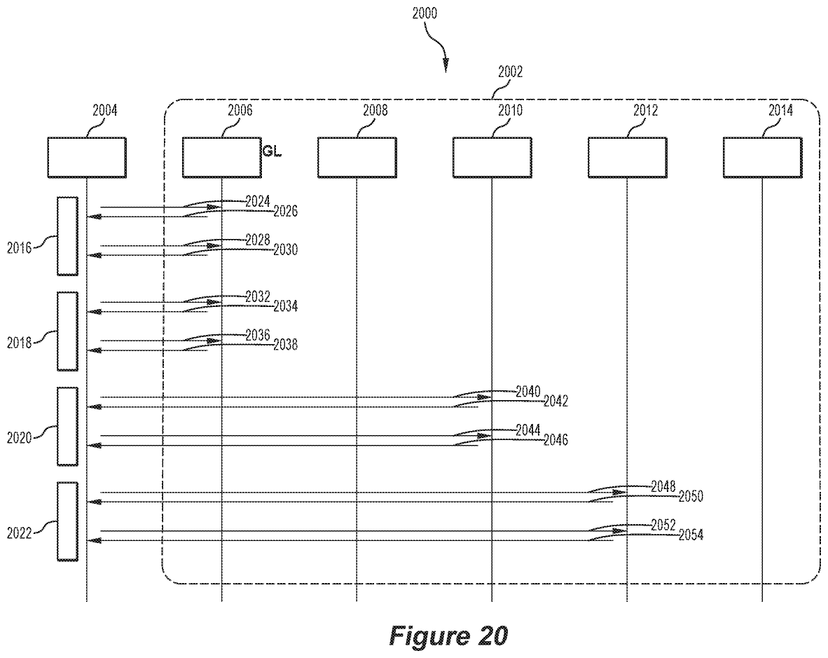

FIG. 20 shows a sequence diagram 2000 which exemplifies a process using the security hierarchy shown in FIG. 19, which is implemented on the EMV (DTPU) 2002. The process includes the following steps:
Step 1: The user uses the embedded screen to select the new active application;
Step 2: the MCU 2004 runs the selection business rule, checks the state (LOCK/UNLOCK) of applications 2024, 2032, selects the set of scripts to run, runs the script with LOCK command 2036 to deactivate the presently active application, and runs the script with UNLOCK command 2028 to activate the application selected by the user;
Step 3: the MCU updates PPSE 2010 FCI, selects the next available authentication script 2040, and sends a SELECT PPSE command and UPDATES FCI 2044 according to activated application AID;
Step 4: the MCU updates the PSE 2012 payment directory, selects the next available authentication script 2048, and sends a SELECT PSE command and UPDATES the Payment Directory 2052 according to activated application AID.

The MCU implements the business rule, which implies having an up-to-date registry of the activated/deactivated applications, and implies having the MCU building scripts for both LOCK/UNLOCK mechanisms and the PPSE and PSE update. The authentication scripts use ISD keys, which are the most sensitive keys of the secure element as they can grant card content management capabilities. In GPS, the minimum security level of the ISD mandates that the script is obtained only from the TSM and not appended in the MCU. Further, a large number of scripts may need to be stored for this example implementation. However, if the MCU is not a secured device, having such responsibilities may require additional security checks.

The script stored contains the APDU commands for Authentication using the custom SSD 2008 keyset. The secure channel 2016, 2018, 2020, 2022 used is SCP02i55. The security level is set to AUTHENTICATED+MAC+ENCRYPTION by the ISD 2006 (which has the Global Lock (GL) privilege). The MCU is not capable of appending the script with new commands, so the LOCK and UNLOCK commands need to be generated by the TSM.

Throughout the process shown in FIG. 20, a number of confirmation steps are implemented, whereby “OK” messages 2026, 2030, 2034, 2038, 2042, 2046, 2050, and 2054 are sent by various actors to confirm a step in the process has been completed successfully. Also shown in FIG. 20 is a Banking Applet 2014.

As previously discussed, in embodiments, scripts which are used to perform a selection of a MMPC cannot be reused, and may be discarded. This requires replenishment of the scripts to allow a user of a DTC with a plurality of MMPCs to change between personalities represented by the MMPCs.

In an embodiment, scripts are replenished when the number of available scripts falls to a predetermined threshold. The cardholder can be notified by a warning signal on the DTC, such as an icon on the DTC display, or by an audible alarm. The cardholder may also be warned by means off the card, such as an SMS to their mobile phone.

The cardholder can replenish scripts by sending a request to a TSM via a mobile phone, an ATM, an EFTPOS/POS terminal, or some other suitable means, whereupon the TSM can use a keyset specific to the cardholder's DTC (for example, the keyset may be specific to the EMV on the DTC) to generate new scripts. The scripts can be sent securely via the means (mobile phone, ATM, EFTPOS/POS) to be downloaded into the MCU of the DTC.

It will be appreciated that the scripts, having been created with the keyset specific to the cardholder's DTC, cannot be used with another DTC. In this regard, scripts which are intercepted by a third party cannot be maliciously used to operate other MMPCs on another DTC.

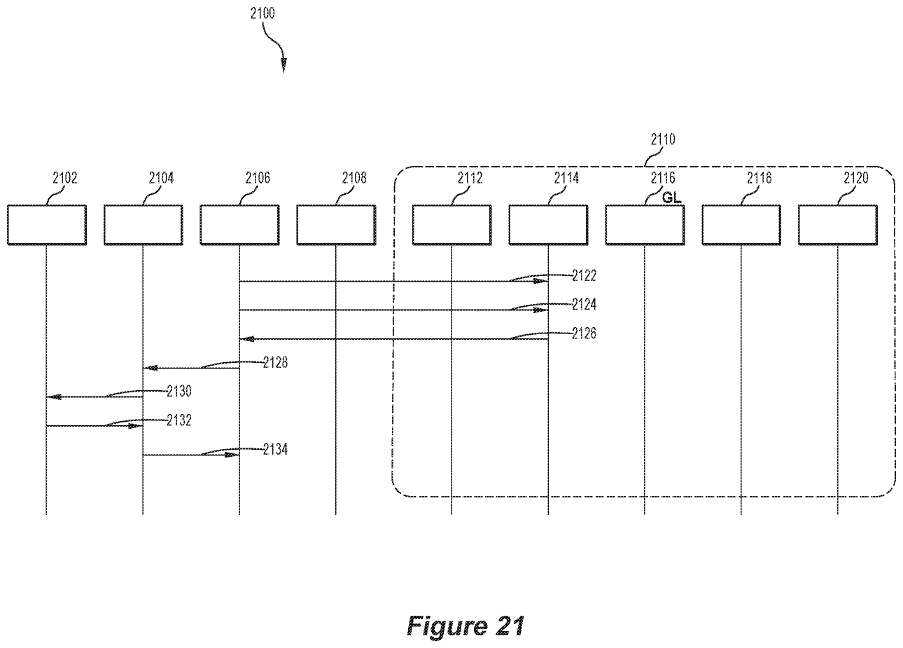

FIG. 21 shows an example replenishment functional sequence 2100, operating with a DTC having an EMV (DTPU) 2110 and a security hierarchy including an ISD 2112, and a custom SSD 2114, along with a PPSE 2116, A PSE 2118 and a Banking Applet 2120, wherein:
Step 1: The user performs a selection. The number of available offline selection (sequence counter threshold) is exceeded;
Step 2: On the next connection to the mobile phone 2104:
   The MCU 2106 selects 2122 the custom SSD 2114 sends the INITIALIZE UPDATE APDU command 2124 to get the sequence counter value from the custom SSD, with the state of the MCU to EMV communication channel being OPEN 2108,
   The MCU pushes to the phone a request 2128 to replenish the scripts, including the counter value;
Step 3: The phone forwards 2130 this request to the TSM 2102;
Step 4: The TSM generates N new scripts for the MCU:
   Using SCP02i55 with the custom SSD SCP keys and the sequence counter received in the request,
   Forwards 2132 the script to the MCU through the phone connectivity. Using SCP02i55 with the custom SSD SCP keys and the sequence counter received in the request,
   Forwards 2134 the script to the MCU through a mobile phone connection.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference to any prior art in this specification is not and should not be taken as an acknowledgement or any form of suggestion that the prior art forms part of the common general knowledge.

What is claimed is:

1. Apparatus on a Digital Transaction Card (DTC) operable in accordance with a standard command protocol, the apparatus comprising:
hardware operable with at least one application for executing one or more instructions from the standard command protocol; and
software operable to store one or more software packages, at least one of the one or more software packages representing a Modified Virtual Card Profile (MVCP),
the apparatus operable with the MVCP to cause the DTC to adopt the personality associated with the MVCP.

2. Apparatus according to claim 1, further comprising:
a MVCP distribution infrastructure comprising at least one MVCP distribution device operable to provide at least one MVCP to the DTC.

3. Apparatus according to claim 1, wherein the apparatus is operable to store at least one script, the script when executed, operable with at least one of the one or more software packages to cause the DTC to operate in accordance with at least one command from the standard command protocol.

4. Apparatus according to claim 1, wherein the apparatus is adapted to securely store keys and/or key pairs for Issuer Security Domain (ISD) and/or Supplementary Security Domain (SSD) level security rights.

5. Apparatus according to claim 1, wherein the apparatus is adapted to store a plurality of MVCPs.

6. Apparatus according to claim 1, wherein the apparatus is operable to store at least one script, the script when executed, operable with at least one of the one or more software packages to cause the DTC to operate in accordance with at least one command from the standard command protocol,
wherein the apparatus is adapted to securely store keys and/or key pairs for Issuer Security Domain (ISD) and/or Supplementary Security Domain (SSD) level security rights,
wherein the apparatus is adapted to store a plurality of MVCPs, and
wherein, using any one or more of keys, key pairs and at least one script to operate at least one command from the standard command protocol, a selected MVCP is rendered operable for digital transactions using the DTC, and one or more non-selected MVCPs are rendered inoperable for digital transactions using the DTC.

7. Apparatus according to claim 1, wherein the standard command protocol is the Global Platform Standard (GPS).

8. Apparatus according to claim 1, wherein the apparatus further includes a secure element for securely storing any one or more of keys, key pairs and at least one script.

9. Apparatus according to claim 1, wherein the DTC operable to receive data from a Data Assistance Device (DAD), the DAD including:
a DAD user interface;
a DAD processor; and
a DAD transceiver,
in which:
the DAD is operable to receive data from an external third party,
the DTC and DAD are enabled to transfer data from the DAD to the DTC; and
the transfer of data from the DAD to the DTC is effected by the DAD processor and the DTC external processor and respective transceivers.

10. Apparatus according to claim 1, wherein the MVCP, or one or more of the plurality of MVCPs is a Modified Mobile Payment Card (MMPC).

11. A method for operating apparatus on a Digital Transaction Card (DTC) operable in accordance with a standard command protocol, the apparatus including hardware operable with at least one application for executing one or more instructions from the standard command protocol, and software operable to store one or more software packages, at least one of the one or more software packages representing a Modified Virtual Card Profile (MVCP), the method comprising:
operating the apparatus with the MVCP to cause the DTC to adopt the personality associated with the MVCP.

12. Method according to claim 11 wherein the apparatus further comprises a MVCP distribution infrastructure including at least one MVCP distribution device operable to provide at least one MVCP to the DTC, and wherein the method further comprises operating the DTC to receive at least one MVCP from the MVCP distribution device.

13. Method according to claim 11, further comprising, receiving, from an issuing authority, a DTC configured to operate in accordance with the standard command protocol.

14. Method according to claim 11, further comprising, issuing, by an issuing authority, a DTC configured to operate in accordance with the standard command protocol.

15. Method according to claim 11, further comprising, issuing, by an issuing authority, operating code, including software and/or firmware, to a Digital Transaction Card (DTC) to enable the DTC to operate in accordance with any one of claims 1 to 5.

16. Method according to claim 11, further comprising, issuing, by an issuing authority, operating code, including software and/or firmware, to a Digital Transaction Card (DTC) to enable the DTC to operate in accordance with any one of claims 1 to 5.

17. A method for operating a system for digital transactions operable in accordance with a standard command protocol, the system including apparatus on a Digital Transaction Card (DTC) including hardware operable with at least one application for executing one or more instructions from the standard command protocol and software operable to store one or more software packages, at least one of the one or more software packages representing a Modified Virtual Card Profile (MVCP), the apparatus operable with the MVCP to cause the DTC to adopt the personality associated with the MVCP; and a MVCP distribution infrastructure including at least one MVCP distribution device operable to provide at least one MVCP to the DTC, the method comprising:
operating the at least one MVCP distribution device to provide at least one MVCP to the DTC.
